(19) United States
(12) Patent Application Publication
(10) Pub. No.: US 2019/0066164 A1
(43) Pub. Date: Feb. 28, 2019

(54) APPARATUS FOR PROVIDING ADVERTISING EVENT CREATION TOOL AND METHOD FOR THE SAME

(71) Applicant: GENIEWORKS, INC, Seoul (KR)

(72) Inventor: Ang LEE, Seoul (KR)

(73) Assignee: GENIEWORKS, INC, Seoul (KR)

(21) Appl. No.: 15/840,716

(22) Filed: Dec. 13, 2017

(30) Foreign Application Priority Data
Aug. 25, 2017 (KR) 10-2017-0108017

(51) Int. Cl. G06Q 30/02; A63F 13/61

(52) U.S. Cl. CPC G06Q 30/0276; A63F 13/61; G06Q 30/0207; G06Q 30/0277

(57) ABSTRACT

Disclosed herein is an apparatus for providing an advertising-event-authoring tool, which includes an advertising product information setting unit for setting information about a product to be advertised, which is a target of an advertising event, depending on input from a user or a user terminal; an advertising event type setting unit for setting an advertising event type; an advertising event content setting unit for setting advertising event content; a reward information setting unit for setting information about rewards for participants in the advertising event; and an advertising event data generation unit for generating advertising event data based on the set information.

### CROSS REFERENCE TO RELATED APPLICATION

This application claims the benefit of Korean Patent Application No. 10-2017-0108017, filed Aug. 25, 2017, which is hereby incorporated by reference in its entirety into this application.

### BACKGROUND OF THE INVENTION

### 1. Technical Field

The present invention relates generally to an advertising-event-authoring tool for easily creating an advertising event, and more particularly to an apparatus and method for providing an advertising-event-authoring tool for constructing a platform through which an advertising event may be easily created.

### 2. Description of the Related Art

These days, smartphone applications may be easily provided through an Application Store (App Store), and various kinds of services using smartphone applications and the web are being provided through a preinstalled mobile WebKit.

Business operators who provide products or services always want to expose their products and services to people using efficient advertisement. In the past, conventional media, such as televisions, newspapers, and the like, were used for advertising, but now, with the development of online media, it is common to use online sites and Social Network Services (SNSs) for advertising. When an advertisement is posted on online sites or SNSs, a promotion is offered or an event is held in order to attract public attention. Here, a promotion or event focuses on a method for offering benefits to a small number of people.

Meanwhile, in order to advertise products, various advertising methods are being used. However, whenever a new advertising campaign is planned, an advertiser must newly design, produce, and manage an advertisement with the help of an advertising agency, which is inefficient. Many big advertisers entrust advertising agencies with tasks related to events and promotion, and the advertising agencies earn profits by planning, designing and running the events and promotion on behalf of the advertisers, but small advertisers plan, design and run events and promotion by themselves. Accordingly, a tool for efficiently creating an advertising event is required.

The above-described information about the related art has been retained by the inventors for the purpose of developing the present invention or was obtained during the process of developing the present invention. Also, it should be appreciated that this information did not necessarily belong to the public domain before the patent filing date of the present invention.

### DOCUMENTS OF RELATED ART

(Patent Document 1) Korean Patent Application Publication No. 10-2013-0015015.

### SUMMARY OF THE INVENTION

An object of the present invention is to provide an apparatus and method for providing an authoring tool for creating various advertising events.

Another object of the present invention is to provide an apparatus and method for providing an advertising-event-authoring tool through which content obtained from a content library may be added to an advertising event.

A further object of the present invention is to provide an apparatus and method for providing an advertising-event-authoring-tool for reading content in the form of a library from a content platform such as a content store.

Yet another object of the present invention is to provide an apparatus and method for providing an advertising-event-authoring tool that provides statistical information generated by collecting information about the results of created advertising events.

Still another object of the present invention is to provide an apparatus and method for providing an advertising-event-authoring tool for determining which event method and reward are more advantageous to an advertiser based on collected statistical information.

An embodiment of the present invention provides an apparatus for providing an advertising-event-authoring tool, which includes an advertising product information setting unit for setting information about a product to be advertised, which is a target of an advertising event, depending on input from a user or a user terminal; an advertising event type setting unit for setting an advertising event type; an advertising event content setting unit for setting advertising event content; a reward information setting unit for setting information about rewards for participants in the advertising event; and an advertising event data generation unit for generating advertising event data depending on the set information.

Here, the advertising event content setting unit may provide a content list of a content library to the user, and add content selected by the user as the advertising event content.

Here, the content library may be a content platform library in a content platform, or a content platform library received from the content platform, and the content platform may be configured to store content in a form of a library in the content platform library, produced and registered by a content producer, and to provide the registered content to users, either for payment or at no cost based on a set pricing model.

Here, the advertising event content may include one or more of text, an image, sound, a video, an animation, and a mini-game, and the advertising event content setting unit may change one or more of a difficulty level, an item, a background, a character, an object, and a goal of the mini-game based on the information about the product to be advertised, thereby creating a mini-game customized to the product to be advertised.

Here, the apparatus may further include an advertising result analysis unit for collecting advertising results of advertising events that are created and underway or completed, generating statistical information based thereon, and analyzing a correlation of the advertising results with one or more of a type of the product to be advertised, the advertising event type, the advertising event content, and the information about the rewards.

Here, the advertising result analysis unit may select at least one of a recommended advertising event type, recommended advertising event content, and recommended reward information suitable for the product to be advertised, using the correlation; when there is a recommended advertising event type corresponding to the product to be advertised, the advertising event type setting unit may provide the recommended advertising event type; when there is recommended advertising event content corresponding to the product to be advertised, the advertising event content setting unit may provide the recommended advertising event content; and when there is recommended reward information corresponding to the product to be advertised, the reward information setting unit may provide the recommended reward information.

Here, the advertising event type setting unit may provide an advertising-event-authoring template corresponding to the advertising event type when the advertising event type is set.

Here, the apparatus may further include an advertising event preview provision unit for providing a preview screen for an advertising event based on the set information.

Here, the advertising result analysis unit may calculate a predicted advertising result corresponding to a target advertising event using an event parameter and a media parameter, the event parameter being calculated from at least one of an event time, an event type, a type of prize, a number of prizes, and a target group for advertising events that are created and underway or completed, and the media parameter being calculated from at least one of a type of event media corresponding to the advertising events, a characteristic of the event media, and a demographic group that mainly uses the event media.

Here, the predicted advertising result may be provided during a process of creating the target advertising event or before the target advertising event is started, and may include at least one of an estimated number of participants and an estimated number of entries.

Another embodiment of the present invention provides a method for providing an advertising-event-authoring tool, which includes setting information about a product to be advertised, which is a target of an advertising event, depending on input from a user or a user terminal; setting an advertising event type; setting advertising event content; setting information about rewards for participants in the advertising event; and generating advertising event data depending on the set information.

Here, setting the advertising event content may be configured to provide a content list of a content library to the user, and to add content selected by the user as the advertising event content.

Here, the content library may be a content platform library in a content platform or a content platform library received from the content platform, and the content platform may be configured to store content in a form of a library in the content platform library, produced and registered by a content producer, and to provide the registered content to users, either for payment or at no cost depending on a set pricing model.

Here, the advertising event content may include one or more of text, an image, sound, a video, an animation, and a mini-game, and setting the advertising event content may be configured to change one or more of a difficulty level, an item, a background, a character, an object, and a goal of the mini-game based on the information about the product to be advertised, and to thereby create a mini-game customized to the product to be advertised.

Here, the method may further include analyzing advertising result by collecting advertising results of advertising events that are created and underway or completed, generating statistical information based thereon, and analyzing a correlation of the advertising results with one or more of a type of the product to be advertised, the advertising event type, the advertising event content, and the information about the rewards

Here, analyzing the advertising results may be configured to select at least one of a recommended advertising event type, recommended advertising event content, and recommended reward information suitable for the product to be advertised, using the correlation; setting the advertising event type may be configured to provide a recommended advertising event type when there is the recommended advertising event type corresponding to the product to be advertised; setting the advertising event content may be configured to provide recommended advertising event content when there is the recommended advertising event content corresponding to the product to be advertised; and setting the information about the rewards may be configured to provide recommended reward information when there is the recommended reward information corresponding to the product to be advertised.

Here, setting the advertising event type may be configured to provide an advertising-event-authoring template corresponding to the advertising event type when the advertising event type is set.

Here, analyzing the advertising results may be configured to calculate a predicted advertising result corresponding to a target advertising event using an event parameter and a media parameter, the event parameter being calculated from at least one of an event time, an event type, a type of prize, a number of prizes, and a target group for advertising events that are created and underway or completed, and the media parameter being calculated from at least one of a type of event media corresponding to the advertising events, a characteristic of the event media, and a demographic group that mainly uses the event media.

Here, the predicted advertising result may be provided during a process of creating the target advertising event or before the target advertising event is started, and may include at least one of an estimated number of participants and an estimated number of entries.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that shows the configuration of a system for providing an advertising-event-authoring tool according to an embodiment of the present invention;

FIG. 2 is a block diagram that shows an example of the configuration of the apparatus for providing an advertising-event-authoring tool illustrated in FIG. 1;

FIG. 3 is a flowchart that shows a method for providing an advertising-event-authoring tool according to an embodiment of the present invention;

FIG. 4 is a flowchart that shows an example of the step of setting advertising event content illustrated in FIG. 3;

FIG. 5 is a view that shows an example of an advertising event including a mini-game in an embodiment of the present invention;

FIG. 6 is a view that shows an example of an advertising event result report page according to an embodiment of the present invention;

FIG. 7 is a view that shows an example of an advertising event type selection page according to an embodiment of the present invention;

FIGS. 8 to 13 are views that show an example of an advertising event creation page according to an embodiment of the present invention;

FIG. 14 is a view that shows an example of a prize-setting page according to an embodiment of the present invention;

FIGS. 15 to 21 are views that show an example of an advertising event page according to an embodiment of the present invention;

FIG. 22 is a view that shows an example of an advertising event list page according to an embodiment of the present invention;

FIG. 23 is a view that shows an example of an advertising event result page according to an embodiment of the present invention;

FIGS. 24 and 25 are views that show an example of an advertising event result details page according to an embodiment of the present invention;

FIG. 26 is a view that shows an example of an event status page according to an embodiment of the present invention;

FIG. 27 is a view that shows an example of an event recommendation page according to an embodiment of the present invention;

### DESCRIPTION OF THE PREFERRED EMBODIMENTS

The present invention may be variously changed, and may have various embodiments, and specific embodiments will be described in detail below with reference to the attached drawings. The effects and features of the present invention and methods of achieving them will be apparent from the following exemplary embodiments, which will be described in more detail with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

However, the present invention is not limited to the embodiments to be described below, but all or some of the embodiments may be selectively combined and configured, so that the embodiments may be modified in various ways. It will be understood that, although the terms “first,” “second,” etc. may be used herein to describe various elements, these elements are not intended to be limited by these terms. These terms are only used to distinguish one element from another element. Also, a singular expression includes a plural expression unless a description to the contrary is specifically pointed out in context. Also, it should be understood that terms such as “include” or “have” are merely intended to indicate that features, components, parts, or combinations thereof are present, and are not intended to exclude the possibility that one or more other features, components, parts, or combinations thereof will be present or added.

Hereinafter, embodiments of the present invention will be described in detail with reference to the accompanying drawings. In the following description of the present invention, the same reference numerals are used to designate the same or similar elements throughout the drawings, and repeated descriptions of the same components will be omitted.

The present invention relates to technology in which a method for effectively running an event, logic for drawing a winner, a process for transparently and fairly drawing a winner, and a solution for determining which benefit and which event type are advantageous to an advertiser are provided through an event-authoring tool.

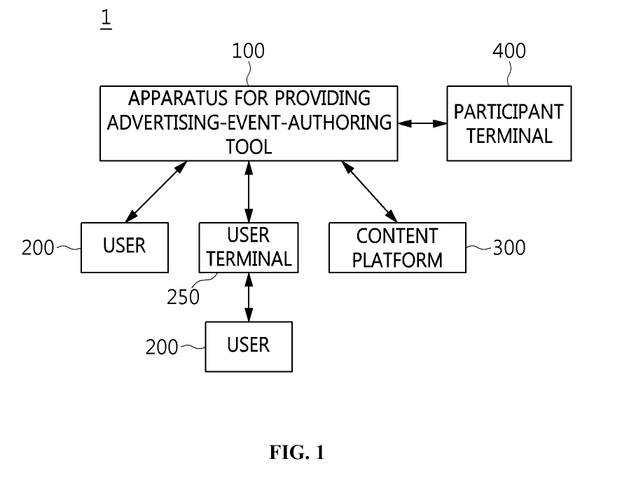

FIG. 1 is a view that shows the configuration of a system 1 for providing an advertising-event-authoring tool according to an embodiment of the present invention.

Referring to FIG. 1, in the system 1 for providing an advertising-event-authoring tool according to an embodiment of the present invention, an apparatus 100 for providing an advertising-event-authoring tool is interconnected with a user 200, a user terminal 250, a content platform 300, and a participant terminal 400.

The apparatus 100 for providing an advertising-event-authoring tool according to an embodiment of the present invention is configured to set information about the product to be advertised through an advertising event, the type of the advertising event, advertising event content, and information about rewards to be offered to participants in the advertising event depending on input from the user 200 or the user terminal 250, and to generate advertising event data depending on the set information.

Here, the types of advertising events may include ‘simple entry’, ‘participation in game’, ‘participation in advertisement and game’, ‘custom event’, and a combination thereof. Also, advertising event content may include mini-games, videos, images, animations, text, and the like. Also, reward information is information in which rewards for an advertising event, criteria for offering rewards, and the like are specified. For example, when ‘participation in game’ is set as the advertising event type, reward information may specify that different rewards are offered to participants depending on their ranks, a reward is offered to a participant who is drawn from among those who scored more than a certain number of points, rewards are offered to those who are ranked at a certain place, or a reward is offered to a randomly drawn participant regardless of ranks or points.

Particularly, advertising event data may be generated so as to be provided on a webpage, and may be provided to various participant terminals 400 via mobile webpages.

Here, chances to participate in a mini-game may be limited. The chance to participate in a mini-game may be obtained after a certain time or may be purchased, or coins or tickets for buying a chance to participate in a game may be received by participating in advertisement.

Here, the apparatus 100 for providing an advertising-event-authoring tool may provide a content list of a content library to a user, and may set content selected by the user as advertising event content.

Here, the content library includes various content that can be set as advertising event content by a user 200, and the user 200 may set advertising event content merely by selecting the content in the content library. That is, the user 200 may create content and use the content as advertising event content, but may also use content included in the content library as the advertising event content.

Here, the content library of the apparatus 100 for providing an advertising-event-authoring tool may be a content platform library in the content platform 300, or may be a content platform library received from the content platform 300. When the apparatus 100 for providing an advertising-event-authoring tool receives the content platform library from the content platform 300, the received content platform library may be stored in a content library storage unit, and the stored content platform library may be used.

Here, the apparatus 100 for providing an advertising-event-authoring tool may include one or more of text, an image, sound, a video, an animation, and a mini-game as advertising event content, and may change one or more of a difficulty level, an item, a background, a character, an object, and a goal of a mini-game based on information about the product to be advertised when the advertising event content is the mini-game, thereby creating a mini-game customized to the product to be advertised.

Here, the apparatus 100 for providing an advertising-event-authoring tool may generate statistical information by collecting the results of advertising events that are progressing or completed, and may analyze the advertising results.

For example, the number of exposures, the approximate number of participants, the effective number of participants, the satisfaction of participants, participants' ages, genders and occupations, advertising costs, and the like are collected as advertising results of the created advertising event, and statistical information may be generated based thereon. Here, the number of exposures may be the number of times the advertising event is shown to users, the approximate number of participants may be the number of participants who access the advertising event page, and the effective number of participants may be the number of participants who actually enter the advertising event by accessing the advertising event page and executing the advertising event content.

Here, participant information may be information required of a participant in order to offer a reward and to analyze a result. For example, the participant information may include a name, contact information, an address, a gender, an age, an occupation and the like.

Also, the statistical information to be generated may include categories based on ages, genders, occupations, and the like of participants, and may include the effective number of participants, the satisfaction of participants, the re-participation rate of participants, and the like for each category.

Particularly, when creating a new advertising event, the advertising results of advertising events may be used to calculate the predicted advertising result of the new advertising event. Here, the predicted advertising result may include the estimated number of participants, the estimated number of visitors, an estimated participation rate, the estimated satisfaction of participants, an estimated re-participation rate, and the like.

Here, using the statistical information, the apparatus 100 for providing an advertising-event-authoring tool may generate a report on the results of advertising events.

Here, the report includes the results of advertising events corresponding to the set advertising event type or statistical information thereabout, and the information included in the report may be categorized depending on report categorization conditions.

Here, the apparatus 100 for providing an advertising-event-authoring tool may analyze the correlation of advertising results with one or more of the kind of product to be advertised, the advertising event type, the advertising event content, and the reward information.

That is, the kind of product to be advertised and the advertising event type are grouped, and the correlation thereof with the advertising result may be analyzed, or the kind of product to be advertised, the advertising event type, and the advertising event content are grouped, and the correlation thereof with the advertising result may be analyzed.

For example, when the product to be advertised is sneakers, if setting an advertising event type to ‘participation in game’ brings a better advertising result or effect than when ‘simple entry’ is set as the advertising event type, this may be analyzed as the correlation between an advertising event type and an advertising result. Also, when the product to be advertised is sneakers and when an advertising event type is set to ‘participation in game’, if selecting a mini-game in which a character wearing the sneakers is running as the advertising event content brings a better advertising result or effect than when a mini-game irrelevant to the product is selected as the advertising event content, this may be analyzed as the correlation between advertising event content and an advertising result. Also, the correlation between a reward and an advertising result may be analyzed.

Here, an apparatus 100 for providing an advertising-event-authoring tool may calculate a predicted advertising result for a new advertising event using a correlation analysis result, and the predicted advertising result may be calculated and provided before the start of a new advertising event or during the process of creating a new advertising event. The predicted advertising result may be calculated from an event parameter, which is calculated using information about the advertising event, and a media parameter, which is calculated using information about the media through which the advertising event is provided. The information about the advertising event may include an event time, an event type, the type of prize, the number of prizes, a target group, and the like, and the information about the media may include the type of media, the characteristics of the media, the demographic group that mainly uses the media, and the like. That is, the predicted advertising result may be calculated in consideration of the attractiveness of an advertising event as well as information about an advertising media.

Accordingly, using the predicted advertising result, a user may create an advertising event so as to yield a good advertising effect. Also, the user may predict an advertising result even before the created advertising event is publicized.

Here, using the analyzed correlation, the apparatus 100 for providing an advertising-event-authoring tool may select one or more of a recommended advertising event type, recommended advertising event content, and recommend reward information suitable for the product to be advertised.

For example, when the product to be advertised is sneakers, if the provision of an advergame in which a character wearing the sneakers is running brought a good advertising result, an advergame may be selected as a recommended advertising event type when the product to be advertised is sneakers. Also, when the product to be advertised is sneakers, a mini-game in which a character wearing the sneakers is running may be selected as recommended advertising event content. Also, when the product to be advertised is sneakers, a gift certificate for sneakers may be selected as recommended reward information. Here, advergame may refers a game for an advertisement.

Here, if there is a recommended advertising event type corresponding to the product to be advertised, the apparatus 100 for providing an advertising-event-authoring tool may recommend the advertising event type. Also, if there is recommended advertising event content corresponding to the product to be advertised, the apparatus 100 for providing an advertising-event-authoring tool may recommend the advertising event content. Also, if there is recommended reward information corresponding to the product to be advertised, the apparatus 100 for providing an advertising-event-authoring tool may recommend the reward information.

For example, when the product to be advertised is sneakers, an advergame may be recommended as an advertising event type. Also, when the product to be advertised is sneakers, a mini-game in which a character wearing the sneakers is running may be recommended as advertising event content. Also, when the product to be advertised is sneakers, a gift certificate for sneakers may be recommended as a reward.

Furthermore, when recommending an advertising event type, advertising event content, or information about a reward, the calculated predicted advertising result may be provided along with the recommended information.

For example, when the product to be advertised is sneakers, an advergame may be recommended as an advertising event type, and an expected advertising effect when the advergame is selected as an advertising event type may be provided. Similarly, expected advertising effects when other advertising event types are selected may be provided, whereby the predicted advertising results corresponding to the respective advertising event types may be compared with each other.

Here, the apparatus 100 for providing an advertising-event-authoring tool may use methods such as ‘simple recommendation’, ‘recommendation for each item’, ‘recommendation for each business type’, ‘recommendation based on data’, and the like. Specifically, ‘simple recommendation’ is a method in which advertising events that brought good advertising results or effects may be recommended based on conditions, such as an event type, the budget for an event, and the like. Also, ‘recommendation for each item’ is a method in which advertising events that brought good advertising results or effects may be recommended based on conditions such as genders, ages, and occupations of customers, seasons, regions, countries, races, and the like. Also, ‘recommendation for each business type’ is a method in which advertising events that brought good advertising results or effects may be recommended depending on conditions such as the type of business in which an advertiser is engaged, the type of medium, and the like. Also, ‘recommendation based on data’ is a method in which advertising events that brought good advertising results or effects may be recommended depending on conditions such as games, prizes (rewards), methods for drawing a winner, and the like. Also, detailed index items for recommending an advertising event may include the response of participants, advertising effects, and the like depending on participants' genders and ages, the day of the week, the month, and the time of day when the participants enter an advertising event, and the like. Also, the predicted advertising result may be provided when recommending advertising event information.

Here, when the advertising event type is set, the apparatus 100 for providing an advertising-event-authoring tool may provide an advertising-event-authoring template corresponding to the advertising event type.

For example, when the advertising event type is set to mini-game advertisement, a list of content for configuring a mini-game is provided from a content library, and a user selects content in the list, whereby advertising event content may be set. Also, when the advertising event type is set to video advertisement, an upload interface for selecting a video, an interface for inputting the address of a video, and the like are provided, and the user may set advertising event content by uploading a video or inputting the address of a video using the provided interface.

That is, the user 200 may easily create an advertising event using an advertising-event-authoring template.

Here, the apparatus 100 for providing an advertising-event-authoring tool may provide a preview screen for the advertising event based on the set information. For example, when a user 200 sets a mini-game in which a character wearing the product to be advertised is running as the advertising event content, the advertising event preview screen may display the mini-game in which a character wearing the product to be advertised is running. Also, the user 200 may check how the mini-game is displayed when a participant participates in the corresponding advertising event.

Here, the apparatus 100 for providing an advertising-event-authoring tool may calculate the advertising cost to be charged for an advertising event service used by the user 200. Particularly, a pricing method may be implemented such that a reward replaces the advertising costs. For example, membership points, electronic money, gift certificates, and the like corresponding to the advertising costs may be used as payment for the advertising costs.

Also, the advertising costs may be automatically calculated by calculating a weighted sum in consideration of the number of exposures of an advertising event, the number of exposures of advertising event content, the length of time during which the advertising event is shown, the length of time during which the advertising event content is shown, the approximate number of participants, the effective number of participants, the number of times a chance to participate in a game is purchased, and the like. Also, different advertising costs may be set depending on windows of time throughout the day in which the advertising event is shown. For example, commuting hours, weekend evenings, and the like are set as peak times, and an extra cost may be applied thereto.

Also, advertising costs are calculated in consideration of variation in past advertising costs, variation in the number of participants in the past, the characteristics of the business type, and the like. Here, a standard price is set in consideration of variation in past advertising costs, variation in the number of participants in the past, the characteristics of the business type, and the like, and the final price is determined through a bid, whereby the advertising event of a successful bidder may be shown at the desired time.

A user 200 may create an advertising event by controlling the apparatus 100 for providing an advertising-event-authoring tool through the user terminal 250.

The user terminal 250 is a terminal that the user 200 uses in order to control the apparatus 100 for providing an advertising-event-authoring tool. Here, the user terminal 250 may be various types of terminals having input/output functions, calculation functions and the like, for example, a laptop, a desktop computer, a smartphone, a tablet PC, or the like.

The content platform 300 includes various content that can be used as advertising event content. Here, the various content may include mini-games, videos, images, and the like.

Here, content is created in the form of an application, or is created so as to be run in an internet browser without installing a special application, and may be created using various programming languages. Also, content may be created using a language with high compatibility such that the content is capable of being run on various kinds of participant terminals 400. For example, content may be created using Hyper-Text Markup Language 5 (HTML5).

Here, content in the content platform 300 may be content that is created for an advertising event and configured such that information related to the product to be advertised may be added therein. For example, the shoes worn by a character in the content may be displayed as the sneakers to be advertised, or an item available in the content may be set to the image of the product to be advertised. Also, the content may be produced as an advergame in which the product to be advertised is shown.

Here, the content platform 300 may be configured to be separate from the apparatus 100 for providing an advertising-event-authoring tool, as shown in FIG. 1, but may be included in the apparatus 100 for providing an advertising-event-authoring tool.

Here, the content platform 300 may be an application store or game store platform. That is, content producers provide content produced by themselves to others, either for payment or at no cost, by registering the content in the content platform 300, and the present invention may be implemented such that a user 200 selects content from the content platform library of the content platform 300, uses the selected content, and pays for the use of the content. That is, when the content registered in the content platform 300 is paid content, the user may use the corresponding content after paying for the same, but when the registered content is free content, the user may use the corresponding content without paying.

The participant terminal 400 is a terminal that a participant uses in order to participate in an advertising event created in the apparatus 100 for providing an advertising-event-authoring tool. Here, the participant terminal 400 may be various types of terminals having input/output functions, calculation functions and the like, for example, a laptop, a desktop computer, a smartphone, a tablet PC, or the like.

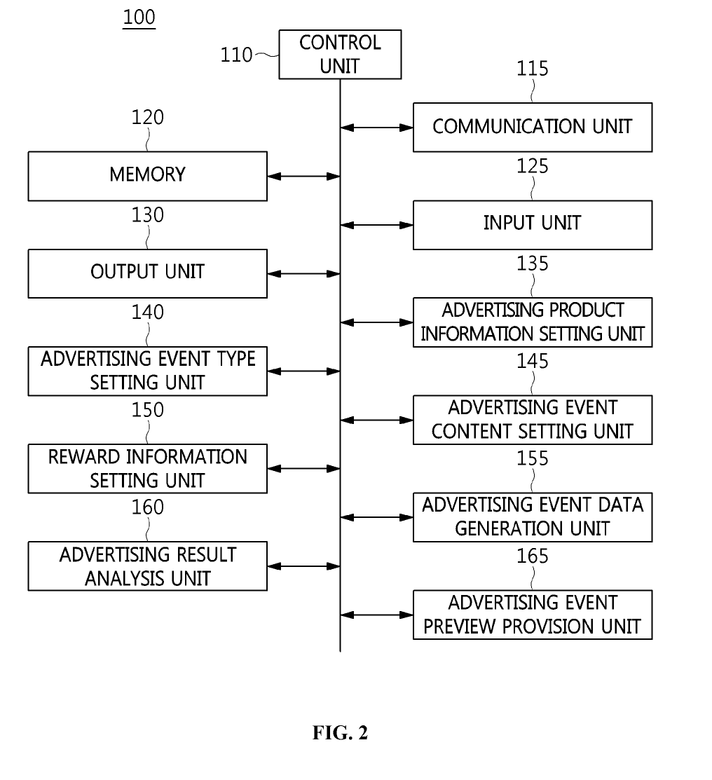

FIG. 2 is a block diagram that shows an example of the configuration of the apparatus 100 for providing an advertising-event-authoring tool, illustrated in FIG. 1.

Referring to FIG. 2, the apparatus 100 for providing an advertising-event-authoring tool according to an embodiment of the present invention includes a control unit 110, a communication unit 115, memory 120, an input unit 125, an output unit 130, an advertising product information setting unit 135, an advertising event type setting unit 140, an advertising event content setting unit 145, a reward information setting unit 150, an advertising event data generation unit 155, an advertising result analysis unit 160, an advertising event preview provision unit 165, and the like.

Specifically, the control unit 110 is a kind of central processing unit, and controls the overall process for providing an advertising-event-authoring tool. That is, the control unit 110 may provide various functions by controlling the communication unit 115, the memory 120, the input unit 125, the output unit 130, the advertising product information setting unit 135, the advertising event type setting unit 140, the advertising event content setting unit 145, the reward information setting unit 150, the advertising event data generation unit 155, the advertising result analysis unit 160, the advertising event preview provision unit 165, and the like.

Here, the control unit 110 may include all kinds of devices capable of processing data, such as a processor and the like. Here, a ‘processor’ may indicate, for example, a data-processing device embedded in hardware, which has a circuit physically structured for performing functions represented as code or instructions included in a program. An example of such a data-processing device embedded in hardware may include processing devices such as a microprocessor, a central processing unit (CPU), a processor core, a multiprocessor, an application-specific integrated circuit (ASIC), a field-programmable gate array (FPGA), and the like, but the present invention is not limited thereto.

The communication unit 115 provides a communication interface that is necessary in order to send or receive signals to or from the user terminal (250 in FIG. 1), the content platform (300 in FIG. 1), and the participant terminal (400 in FIG. 1).

Here, the communication unit 115 may be a device including hardware and software that are necessary in order to send and receive signals, such as control signals or data signals, through a wired or wireless connection with another network device.

Here, the communication unit 115 may create an advertising event by sending and receiving control signals or data signals to and from the user terminal (250 in FIG. 1), and may send information about the progress of the creation of an advertising event, the created advertising event data (or an advertising event campaign), and the like to the user terminal (250 in FIG. 1).

The memory 120 functions to temporarily or permanently store data processed by the control unit 110. Here, the memory 120 may include magnetic storage media or flash storage media, but the present invention is not limited thereto.

The input unit 125 is a device for receiving a control signal for creating an advertising event from the user (200 in FIG. 1). Here, the input unit 125 may include a keyboard, a mouse, a touchpad, a touch panel, and the like.

The output unit 130 outputs information about the progress of the creation of an advertising event, the created advertising event data, and the like when the advertising event is created through the input unit 125. Here, the output unit 130 may include a display device for outputting visual information, a speaker device for outputting sound information, and the like.

The advertising product information setting unit 135 sets information about the product to be advertised, that is, the target of an advertising event to be created.

Here, information about the product to be advertised includes a product name, a product type or a category in which the product is included, a manufacturer, a price, a release date, information about product specifications and product functions, a method of using the product, and the like.

The advertising event type setting unit 140 may set an event type for providing an advertising event.

Here, the advertising event type includes ‘simple entry’, ‘participation in game’, ‘participation in advertisement and game’, ‘custom event’, and a combination thereof.

Specifically, ‘simple entry’ represents an event that a participant may enter after checking the content of the event, and may be useful when only an information page is required to be provided. ‘Participation in game’ represents an event configured such that a chance to enter the event is given to those who participate in a game, and may be useful when a user intends to use a game that provides enjoyment in order to entice participants to enter the event. ‘Participation in advertisement and game’ represents an event configured such that a chance to enter the event is given to those who view a certain advertisement and participate in a game. ‘Custom event’ represents an event configured such that a user can create an event page by himself or herself after writing a brief description of the event, and may be designed using Application Programming Interfaces (APIs) and the like, without limitation as to the format thereof

Here, the advertising event type setting unit 140 may provide an advertising-event-authoring template corresponding to the set advertising event type.

Here, when there is a recommended advertising event type, which is selected based on the advertising result analyzed by the advertising result analysis unit 160, the advertising event type setting unit 140 may recommend the advertising event type. Also, when providing the recommended advertising event type, a predicted advertising result corresponding to the recommended advertising event type may be provided therewith.

The advertising event content setting unit 145 sets advertising event content that is to be included in the advertising event.

Here, the advertising event content includes a brief description of the advertising event, information about the product to be advertised, a component that can be executed by participants as the advertising event, and the like, and may be configured with a mini-game, a video, an image, an animation, sound, text, and the like.

That is, when the advertising event content is set to text, an image, sound, a video, an animation, or the like, it functions to unilaterally deliver information, but when the advertising event is set to a mini-game, not only may information be delivered but active participation may also be encouraged through the interaction with participants, and participants' attention may be attracted.

When a mini-game is set as the advertising event content, the content may include information in which the time at which a chance to play a game is to be provided, the number of chances, the number of products to be used for the game and the discount rate of the products, the game to be provided, and the like are specified.

Particularly, the user (200 in FIG. 1) may select a game that is ideal for the product to be advertised. There is no limitation as to the type of game that can be selected, and a game for randomly drawing a winner, a competitive game for testing memory, and the like may be included. Also, a suitable mini-game may be selected in consideration of the image or characteristics of the product to be advertised.

Here, the advertising event content setting unit 145 may change one or more of the difficulty level, the item, the background, the character, the object, and the goal of a mini-game depending on information about the product to be advertised.

For example, when the product to be advertised is sneakers and a mini-game in which a character runs as far as possible within a limited time is selected, the character of the mini-game may be changed to the image of the celebrity model of the corresponding product, the background may be changed to a playground or a stadium, the sneakers to be advertised may be provided as an item for improving performance in the game, or the goal of the game may be changed to making the character run a set distance as fast as possible, that is, the mini-game may be customized for the product to be advertised.

Here, the advertising event content setting unit 145 provides a content list of the content library, and may set the content selected by the user (200 in FIG. 1) as the advertising event content.

Here, the content library may include various content, which may be set as advertising event content by the user (200 in FIG. 1), and the user (200 in FIG. 1) may set advertising event content merely by selecting the content in the content library. That is, the user (200 in FIG. 1) may create content and use the content as advertising event content, but may alternatively use content included in the content library as the advertising event content.

Here, the content library may be a content platform library in the content platform (300 in FIG. 1), or may be a content platform library received from the content platform (300 in FIG. 1). When the apparatus 100 for providing an advertising-event-authoring tool receives the content platform library from the content platform (300 in FIG. 1), the received content library platform may be stored in a content library storage unit, and the stored content platform library may be used.

Here, when there is recommend advertising event content, which is selected based on the advertising result analyzed by the advertising result analysis unit 160, the advertising event content setting unit 145 may recommend the advertising event content. Also, when providing the recommended advertising event content, a predicted advertising result corresponding to the recommended advertising event content may be provided therewith.

The reward information setting unit 150 sets information about rewards to be offered to participants in the advertising event.

Here, the reward information is information in which rewards for an advertising event, criteria for offering rewards, and the like are specified. That is, the type of rewards, the number of rewards, products to be offered as rewards, and the like for an advertising event may be included.

For example, the criterion for offering a reward may be set so as to offer rewards to the participants in a mini-game depending on their ranks, to offer a reward to a person who is ranked at a certain place, among the participants in the mini-game, to offer a reward to a person randomly drawn from among the participants in the mini-game regardless of the ranks or points, or to offer a reward to a person randomly drawn from among the participants who scored more than a certain number of points in the mini-game. Also, levels may be set depending on points earned in the mini-game, different rewards may be set for the respective levels, and a reward may be offered to one selected from each level.

Here, the reward may be the product to be advertised, a gift certificate for a certain product other than the product to be advertised, a discount coupon, or the like, and may be provided in the form of a mobile voucher, membership points, a gift certificate printed on paper, and the like.

Here, in order to offer a reward, a shopping-mall platform may be connected with the apparatus for providing an advertising-event-authoring tool. That is, a reward may be provided in the form of a gift certificate, a discount coupon, points, and the like available for products registered in the shopping-mall platform. Accordingly, the participant in the advertising event may easily receive the reward for the advertising event using the gift certificate, the discount coupon, or the points offered as the rewards in the corresponding shopping-mall platform.

Here, the shopping-mall platform may be a platform that may function as an online shopping mall. Therefore, the shopping-mall platform may provide functions related to products, such as exhibition, display, management, and the like of products. Also, the shopping-mall platform may provide functions related to members, such as customer management, customer points management, member information management, and the like. Also, the shopping-mall platform may provide functions related to shopping mall services, such as orders, shopping list management, delivery, payments, and the like.

Here, using a customer survey function, the reward information setting unit 150 may provide additional information in order to help a user select a more advantageous reward. For example, the user (200 in FIG. 1) may check participants' preferences for products to be offered as rewards by giving participants a limited number of chances to enter advertising events and making the participants selectively participate in advertising events that provide different rewards, and may then set reward information based on the participants' preferences.

Here, when there is recommended reward information, which is selected based on the advertising result analyzed by the advertising result analysis unit 160, the reward information setting unit 150 may recommend the reward information. Also, when providing the recommended reward information, a predicted advertising result corresponding to the recommended reward information may be provided therewith.

Here, the reward information setting unit 150 may set a reward receiving period, and may cancel any reward that has not been received when the reward receiving period expires.

The advertising event data generation unit 155 generates advertising event data depending on the set information, such as information about the product to be advertised in the advertising event, the advertising event type, the advertising event content, the reward information, and the like. In this specification, the advertising event data and an advertising event campaign may be used interchangeably with each other.

Here, the advertising event data generation unit 155 may generate advertising event data so as to be provided on a webpage or a mobile webpage. That is, advertising event data may be generated such that, even when advertising event content includes a mini-game, the content may be run on the webpage without installing a special application.

The advertising result analysis unit 160 generates statistical information by collecting advertising results of the completed advertising events and advertising results of the advertising events that have been created and are progressing, and analyzes the advertising results based on the statistical information.

Here, the advertising result analysis unit 160 may generate statistical information using the number of advertising exposures, the approximate number of participants, the effective number of participants, the satisfaction of participants, participants' ages, genders and occupations, advertising costs, and the like.

Here, participant information may be information required of a participant in order to offer a reward and to analyze a result. For example, the participant information may include a name, contact information, an address, a gender, the birth date, an age, an occupation, and the like.

Also, the statistical information to be generated may include categories corresponding to ages, genders, occupations, and the like of participants, and may include the percentage of the effective participants, the satisfaction of participants, the re-participation rate of participants, and the like for each category.

Here, the advertising result analysis unit 160 may generate a report on the results of advertising events using the statistical information.

Here, the report includes the results of advertising events corresponding to the set advertising event type or statistical information thereabout, and the information included in the report may be categorized depending on report categorization conditions.

Here, the advertising result analysis unit 160 may analyze the correlation of advertising results with one or more of the kind of product to be advertised, the advertising event type, the advertising event content, and the reward information. That is, the kind of product to be advertised and the advertising event type are grouped, and the correlation thereof with the advertising result may be analyzed, or the kind of product to be advertised, the advertising event type, the advertising event content, and the reward information are grouped, and the correlation thereof with the advertising result may be analyzed.

Here, the advertising result analysis unit 160 may calculate a predicted advertising result corresponding to a new advertising event using a correlation analysis result, and the predicted advertising result may be calculated and provided before the start of a new advertising event or during the process of creating a new advertising event. The predicted advertising result may be calculated from an event parameter, which is calculated using information about the advertising event, and a media parameter, which is calculated using information about the media through which the advertising event is provided. The information about an advertising event may include an event time, an event type, the type of prize, the number of prizes, a target group, and the like, and the information about a media may include the type of media, the characteristics of the media, the demographic group that mainly uses the media, and the like. That is, the predicted advertising result may be calculated in consideration of the attractiveness of an advertising event as well as information about an advertising media. Here, the predicted advertising result may include the estimated number of participants, the estimated number of visitors, an estimated participation rate, the estimated satisfaction of participants, an estimated re-participation rate, and the like.

Here, using the analyzed correlation, the advertising result analysis unit 160 may select one or more of a recommended advertising event type, recommended advertising event content, and recommended reward information suitable for the product to be advertised.

The advertising event preview provision unit 165 provides the preview screen for the advertising event based on the set information. That is, the screen to be displayed when the advertising event data, which are to be generated by the advertising event data generation unit 155, are provided to the participant terminal (400 in FIG. 1) may be provide as a preview screen.

Here, the preview screen for an advertising event may be displayed via the output unit 130. Also, the preview screen for the advertising event may be sent to the user terminal (250 in FIG. 1) via the communication unit 115, and may be displayed in the user terminal (250 in FIG. 1).

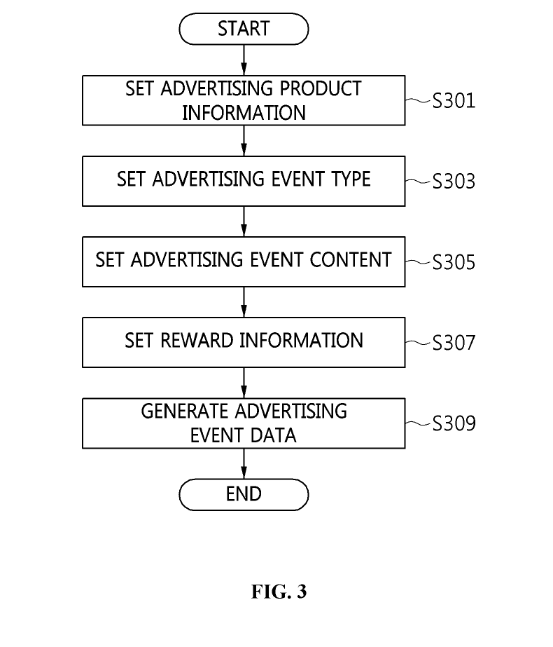

FIG. 3 is a flowchart that shows a method for providing an advertising-event-authoring tool according to an embodiment of the present invention.

Referring to FIG. 3, in the method for providing an advertising-event-authoring tool according to an embodiment of the present invention, the apparatus (100 in FIG. 1) for providing an advertising-event-authoring tool sets information about the product to be advertised through an advertising event at step S301.

Here, information about the product to be advertised may include a product name, the type of product or category in which the product is included, the manufacturer, the price, the release date, information about product specifications and functions, the method of using the product, and the like.

Also, in the method for providing an advertising-event-authoring tool according to an embodiment of the present invention, the apparatus (100 in FIG. 1) for providing an advertising-event-authoring tool sets an advertising event type at step S303.

Here, the advertising event type includes ‘simple entry’, ‘participation in game, ‘participation in advertisement and game’, ‘custom event’, and a combination thereof.

Also, in the method for providing an advertising-event-authoring tool according to an embodiment of the present invention, the apparatus (100 in FIG. 1) for providing an advertising-event-authoring tool sets advertising event content that is to be included in the advertising event at step S305.

Here, the advertising event content includes a brief description of the advertising event, information about the product to be advertised, a component that can be executed by participants as the advertising event, and the like, and may be configured with a mini-game, a video, an image, an animation, sound, text, and the like.

Also, in the method for providing an advertising-event-authoring tool according to an embodiment of the present invention, the apparatus (100 in FIG. 1) for providing an advertising-event-authoring tool sets information about rewards for participation in the advertising event at step S307.

Here, the reward information may be information in which rewards for advertising events, criteria for offering rewards, and the like are specified. That is, the reward information may include the type of rewards, the number of rewards, information about products to be offered as rewards, and the like for the advertising event.

Also, in the method for providing an advertising-event-authoring tool according to an embodiment of the present invention, the apparatus (100 in FIG. 1) for providing an advertising-event-authoring tool generates advertising event data at step S309 depending on the set information, such as information about the product to be advertised in the advertising event, the advertising event type, the advertising event content, the reward information, and the like.

Here, the advertising event data may be generated so as to be provided from a webpage, and may be generated so as to support a mobile webpage.

In an alternative embodiment, among the above steps S301, S303, S305, S307 and S309, setting an advertising event type at step S303 may be performed before setting information about the product to be advertised at step S301.

In an alternative embodiment, among the above steps S301, S303, S305, S307 and S309, setting reward information at step S307 may be performed before setting advertising event content at step S305.

In an alternative embodiment, among the above steps S301, S303, S305, S307 and S309, setting an advertising event type at step S303, setting advertising event content at step S305, and setting information about the product to be advertised at step S301 may be performed in the order in which the steps are listed.

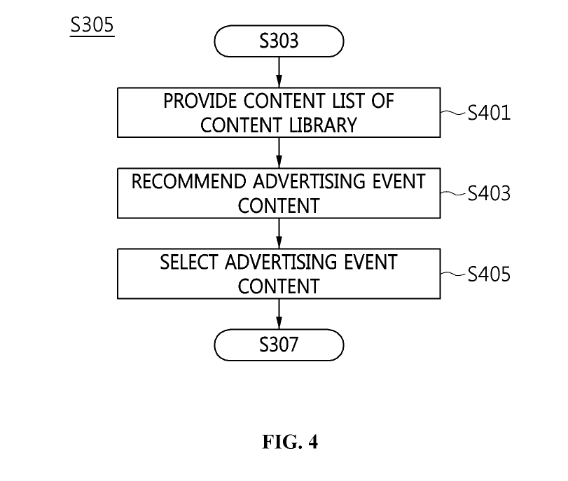

FIG. 4 is a flowchart that shows an example of the step (S305) of setting adverting event content, illustrated in FIG. 3.

Referring to FIG. 4, in the step (S305) of setting advertising event content illustrated in FIG. 3, the apparatus (100 in FIG. 1) for providing an advertising-event-authoring tool provides a content list of a content library at step S401.

Here, the content library includes various content that can be set as advertising event content by the user (200 in FIG. 1).

Here, the content library may be the content platform library in the content platform (300 in FIG. 1), or may be the content platform library received from the content platform (300 in FIG. 1). When the apparatus (100 in FIG. 1) for providing an advertising-event-authoring tool receives the content platform library from the content platform (300 in FIG. 1), the received content platform library may be stored in a content library storage unit, and the stored content platform library may be used.

Also, in the step (S305) of setting advertising event content illustrated in FIG. 3, when there is recommended advertising event content, the apparatus (100 in FIG. 1) for providing an advertising-event-authoring tool recommends the advertising event content at step S403.

Here, the recommended advertising event content may be advertising event content expected to bring a good advertising result or effect because the results of analysis of the advertising results of running or completed advertisements satisfy preset criteria.

Also, in the step (S305) of setting advertising event content illustrated in FIG. 3, the apparatus (100 in FIG. 1) for providing an advertising-event-authoring tool selects advertising event content at step S405.

Here, the user (200 in FIG. 1) may set content as advertising event content merely by selecting the content from the content list. That is, the user (200 in FIG. 1) may produce content and use the same as advertising event content, but may alternatively use content included in the content library as the advertising event content.

In an alternative embodiment, among the above steps S401, S403 and S405, providing a content list at step S401 and recommending advertising event content at step S403 may be performed in parallel.

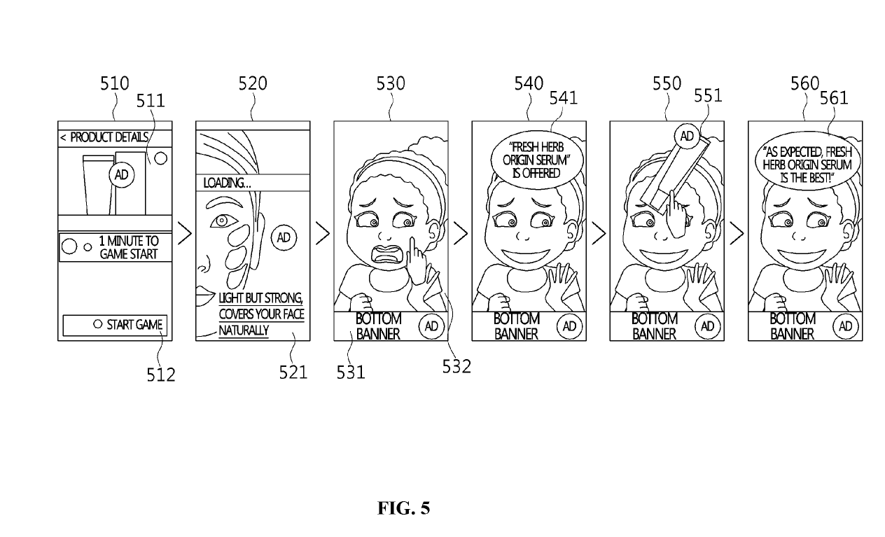

FIG. 5 is a view that shows an example of an advertising event including a mini-game in an embodiment of the present invention.

Referring to FIG. 5, in an embodiment of the present invention, the advertising event including a mini-game includes an advertising event participation page 510. The advertising event participation page may include information 511 about a product to be advertised, information on how to participate in an advertising event, a button 512 for participating in an advertising event, and the like.

Also, in an embodiment of the present invention, when a participant participates in the advertising event, a content-loading page 520, including information 521 about the product to be advertised, is shown in the advertising event including a mini-game.

Also, in an embodiment of the present invention, the advertising event including a mini-game includes advertising event content pages 530, 540, 550 and 560 that provide the mini-game 532. Here, each of the advertising event content pages 530, 540, 550 and 560 may include an advertisement in the form of a banner 531 at the bottom thereof

For example, the mini-game 532 illustrated in FIG. 5 is a mini-game, the goal of which is to wash the face of a character within a preset time by clicking or touching pimples, acne, and the like. In the mini-game, when the number of touches becomes equal to or greater than a preset value, an item imitative of the advertised product may be offered 541, so that a player may be encouraged to actively participate in the mini-game using the offered item 551 corresponding to the advertised product. Also, when the player finishes the mini-game using the offered item 551, a message 561 for promoting the advertised product may be displayed.

That is, the advertised product may be continuously promoted using the banner 531 at the bottom of a page, but the advertised product may be more effectively promoted by implying that the use of the item 551 corresponding to the advertised product produces a good effect in the mini-game 532.

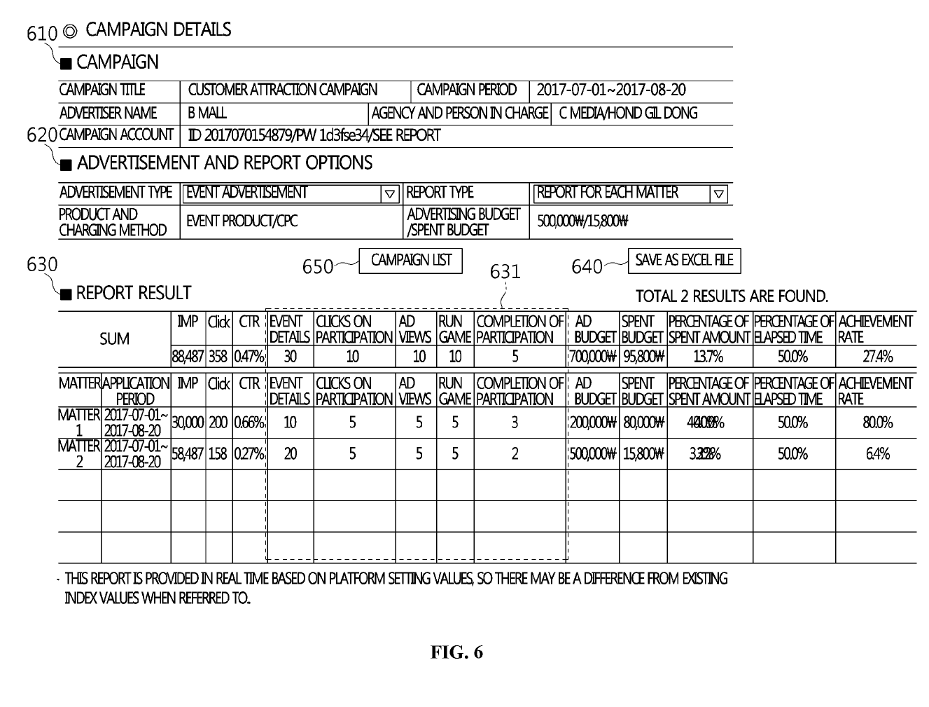

FIG. 6 is a view that shows an example of an advertising event result report page according to an embodiment of the present invention.

Referring to FIG. 6, the advertising event result report page according to an embodiment of the present invention includes summary information 610 about an advertising event campaign, advertisement and report type selection information 620, a result 630, and the like.

Specifically, the summary information 610 about an advertising event campaign may include an advertising event name or a campaign title, a period, the name of a user or an advertiser, an agency, a person in charge, account information, and the like. Also, the advertisement and report type selection information 620 may include information about selectable advertisement types, information about selectable report conditions, product type and charging information, advertising cost information, and the like. Also, in the result 630, an advertisement result report corresponding to the options selected in the advertisement and report type selection information 620 may be displayed in the form of an itemized list. Here, when the product type is an event, additional indices 631 may be provided.

Also, the advertising event result report page according to an embodiment of the present invention may include a button 640 for downloading the advertising result report and saving the same as an Excel or spreadsheet data file.

Also, the advertising event result report page according to an embodiment of the present invention may include a campaign list button 650 for moving to a campaign list page.

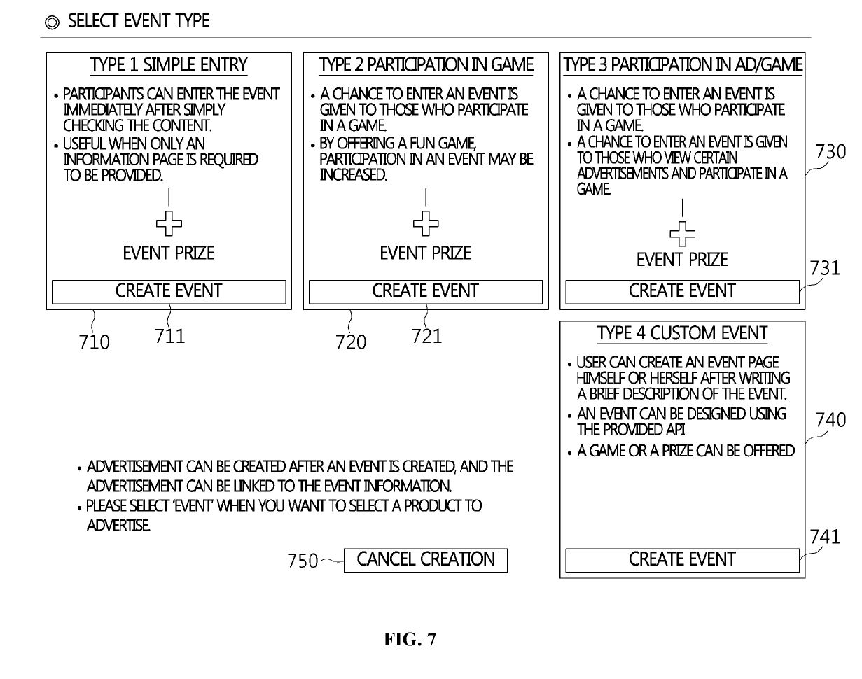

FIG. 7 is a view that shows an example of an advertising event type selection page according to an embodiment of the present invention.

Referring to FIG. 7, the advertising event type selection page according to an embodiment of the present invention may include ‘simple entry’ 710, ‘participation in game’ 720, ‘participation in advertisement and game’ 730, ‘custom event’ 740, and the like as a selectable advertising event type.

Specifically, ‘simple entry’ 710 represents an advertising event that a participant may enter immediately after checking the content thereof, and may be useful when only an information page is required to be provided. In order to select ‘simple entry’ 710 as the advertising event type, the ‘create event’ button 711 may be used.

‘Participation in game’ 720 represents an advertising event configured such that a chance to enter the event is given to those who participate in a mini-game, and may be useful when a user intends to use a game that provides enjoyment in order to entice participants to enter the event. In order to select ‘participation in game’ 720 as the advertising event type, the ‘create event’ button 721 may be used.

‘Participation in advertisement and game’ 730 represents an advertising event configured such that a chance to enter an event is given to those who view a certain advertisement and participate in a game. In order to select ‘participation in advertisement and game’ 730 as the advertising event type, the ‘create event’ button 731 may be used.

‘Custom event’ 740 represents an advertising event configured such that a user can create an event page by himself or herself after writing a brief description of the event, and may be designed using Application Programming Interfaces (APIs) and the like, without limitation as to the format thereof. In order to select ‘custom event’ 740 as the advertising event type, the ‘create event’ button 741 may be used.

Also, the advertising event type selection page according to an embodiment of the present invention may include the ‘cancel creation’ button 750 for canceling the creation of an advertising event, and the creation of an advertising event may be canceled by clicking the ‘cancel creation’ button 750.

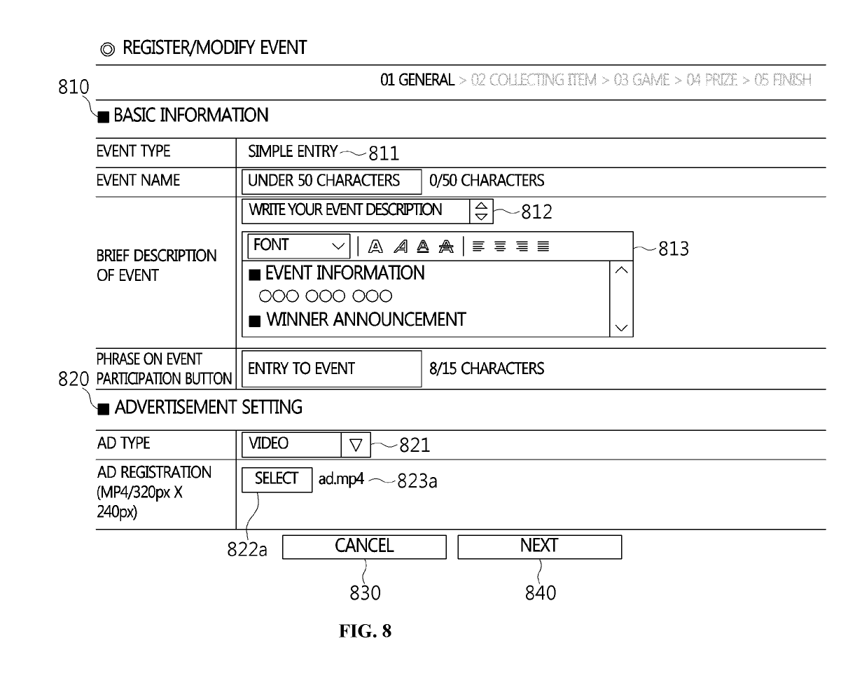

FIGS. 8 to 13 are views that show an example of an advertising event creation page according to an embodiment of the present invention.

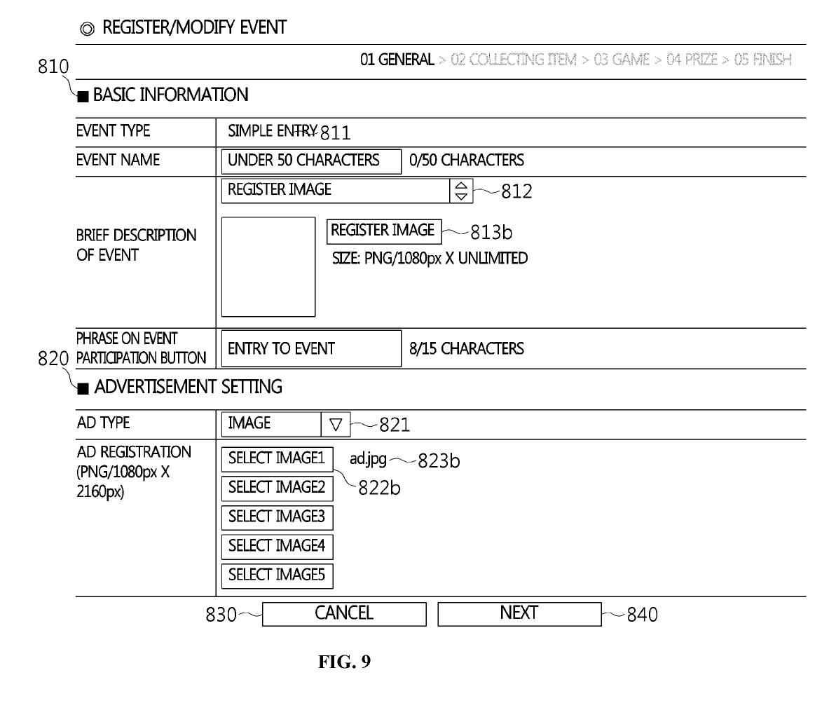

FIG. 8 and FIG. 9 show an advertising event creation page for configuring basic information 810 of an advertising event and advertisement settings 820.

In an embodiment, after one of the advertising event types illustrated in FIG. 7 is selected, the advertising event creation page shown in FIG. 8 and FIG. 9 may be displayed.

Specifically, the basic information 810 of an advertising event may include an advertising event type 811, options 812 for selecting the method of writing a brief description of the advertising event, editable text fields 813a and 813b for writing the brief description of the advertising event, and the like, and the advertisement settings 820 may include an advertisement type 821, buttons 822a and 822b for registering an advertisement, information 823a and 823b about the registered advertisement, and the like.

Here, the options 812 for selecting the method of writing a brief description of an advertising event may include ‘write your event description’, ‘register image’, and the like, and ‘write your event description’ may be the default option. The advertisement type 821 may include ‘image’, ‘video’, and the like.

For example, in FIG. 8, the advertising event type set to ‘simple entry’ is displayed, the editable text field 813a for writing an advertising event description is displayed because ‘write your event description’ is selected from the options 812 for selecting the method of writing a brief description of an advertising event, the advertisement type 821 set to ‘video’ is displayed, the button 822a for selecting a video advertisement is displayed, and advertisement information 823a indicating that encoding is progressing after the registration of the advertisement or indicating the completion of encoding is displayed.

Meanwhile, in FIG. 9, a button 813b for registering an advertising event description image is displayed because ‘register image’ is selected from the options 812 for selecting the method of writing a brief description of an advertising event, the advertisement type 821 set to ‘image’ is displayed, the button 822b for selecting an image advertisement is displayed, and advertisement information 823b indicating that encoding is progressing after the registration of the advertisement or indicating the completion of encoding is displayed.

Also, the creation of the advertising event may be canceled by clicking the ‘cancel’ button 830, or the step of creating the advertising event may be continued by clicking the ‘next’ button 840. Here, the ‘next’ button 840 is disabled by default, but may be enabled when all of the required information is input.

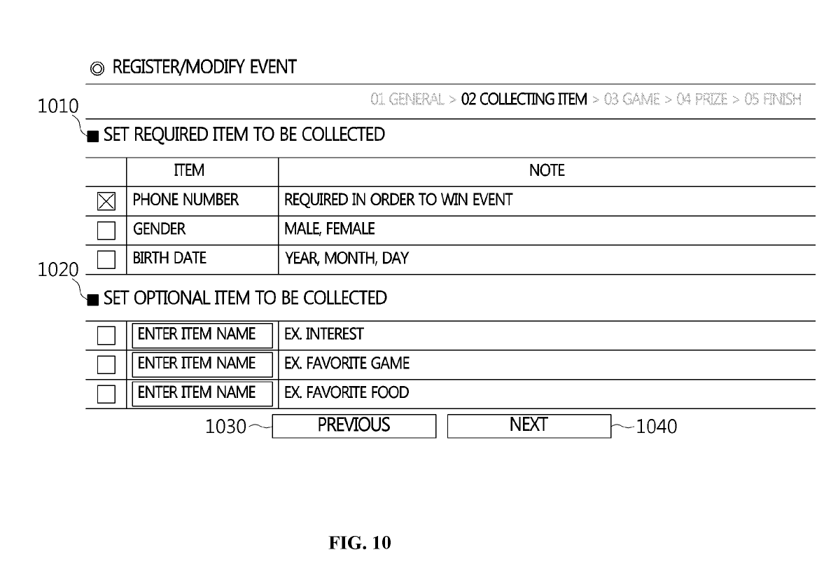

FIG. 10 is an advertising event creation page for setting required items 1010 and optional items 1020 to be collected as information about participants in an advertising event.

In an embodiment, the advertising event creation page illustrated in FIG. 10 may be displayed as the next step of the advertising event creation page illustrated in FIG. 8 or 9.

Here, the required items 1010 to be collected may include a cell phone number, a gender, the birth date, and the like, and the optional items 1020 to be collected may include an occupation, a matter of interest, a favorite game, favorite food, an income level, and the like depending on the selection of the user (200 in FIG. 1). Here, the cell phone number may be included in the required items 1010 by default.

Also, the page may move back to the step of setting the basic information of an advertising event, illustrated in FIG. 8 or 9, by clicking the ‘previous’ button 1030, or the step of creating the advertising event may be continued by clicking the ‘next’ button 1040. Here, the ‘next’ button 1040 is enabled by default, but is switched to a disabled state when an optional item 1020 is selected, and may then be enabled when information is input in the selected optional item.

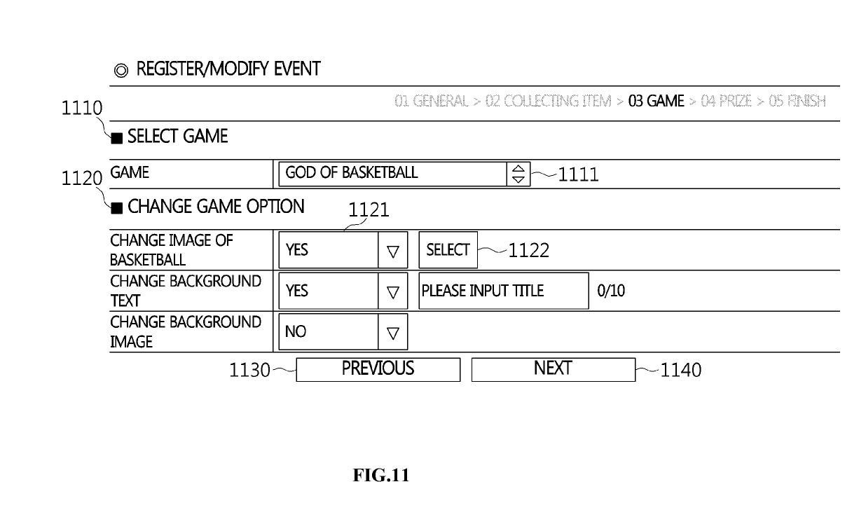

FIG. 11 is an advertising event creation page for selecting a game 1110 and setting game options 1120 when the advertising event includes a game.

In an embodiment, the advertising event creation page illustrated in FIG. 11 may be displayed as the next step of the advertising event creation page illustrated in FIG. 10.

Here, the advertising event creation page illustrated in FIG. 11 may be displayed when the advertising event type is ‘participation in game’ or ‘participation in advertisement and game’, that is, when the selected advertising event type includes a game as the advertising event content. If the selected advertising event type does not include a game as the advertising event content, the advertising event creation page shown in FIG. 11 may not be displayed.

Here, in order to enable the user to select a game 1110, a list box 1111 for selecting a game is included. Here, when the options of the selected game can be changed, items for setting game options 1120 may be displayed. For example, when a ‘basketball’ game is selected and when the options thereof can be changed, a user may decide whether to change the basketball image 1121. Also, when the user decides to change the basketball image, the user may select the image to replace the existing basketball image by clicking the ‘select’ button 1122. Here, the option 1121 for deciding whether to change an image may be set to ‘no’ by default.

Here, the list box 1111 for selecting a game may show the content list of the content platform library provided from the content platform (300 in FIG. 1).

Also, the page may move back to the step of setting items to be collected as information about participants in an advertising event, illustrated in FIG. 10, by clicking the ‘previous’ button, or the step of creating an advertising event may be continued by clicking the ‘next’ button 1140. Here, the ‘next’ button 1140 is disabled by default, but may be switched to an enabled state when a game is selected. Also, when whether to change game options is set to ‘yes’, the ‘next’ button 1140 is disabled, and may then be enabled when the settings of the game options are completed.

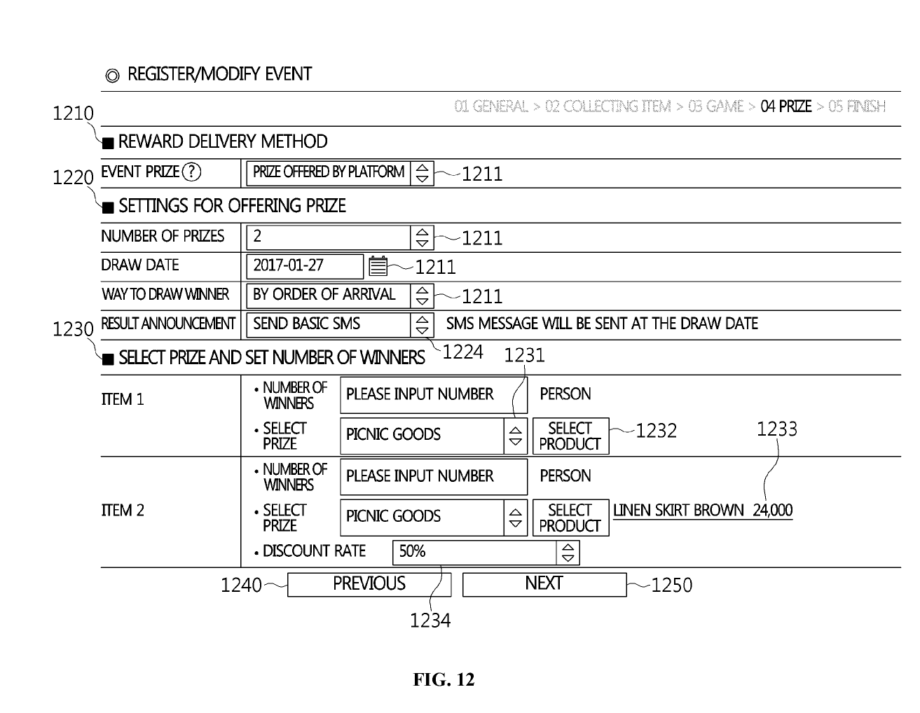

FIG. 12 is an advertising event creation page for selecting a reward (prize) delivery method 1210 and for setting reward information 1220 and information 1230 about the product to be offered as a reward.

In an embodiment, the advertising event creation page illustrated in FIG. 12 may be displayed as the next step of the advertising event creation page illustrated in FIG. 10.

In another embodiment, the advertising event creation page illustrated in FIG. 12 may be displayed as the next step of the advertising event creation page illustrated in FIG. 11.

Here, in order to enable a user to select a reward delivery method 1210, a list box 1211 for selecting a reward delivery method is displayed, ‘prize offered by platform’, ‘input prize’, and the like may be included as selectable options of the reward delivery method, and ‘prize offered by platform’ may be selected by default.

Here, when the reward delivery method 1210 is set to ‘prize offered by platform’, a prize may be offered by a shopping-mall platform that is connected to the page in order to offer a reward. That is, the reward may be offered in the form of a gift certificate, a discount coupon, and points that can be used to buy products registered in the shopping-mall platform. Accordingly, a participant in the advertising event may easily receive a reward for the advertising event using the gift certificate, the discount coupon, or points offered by the shopping-mall platform.

Also, the number of rewards 1221, the draw date 1222, a method of drawing a winner 1223, the result announcement method 1224, and the like may be set as reward information 1220. Options for the method of drawing a winner 1223 may include ‘in order of arrival’, ‘at random’, ‘based on scores in game’, and the like. Options for the result announcement method 1224 may include ‘send basic SMS’, ‘send SMS including link to gift certificate’, ‘push mobile voucher’, and the like.

Also, the information 1230 about the product to be offered as a reward may be generated so as to include as many items as the number of prizes 1221, and the number of winners, a prize, a discount rate, and the like may be set for each item. First, the category in which the product to be offered as a prize is included is selected using the list box 1231 for selecting a prize category, the product to be offered as a prize is selected by clicking the ‘select product’ button 1232, the selected product 1233 is displayed, and the discount rate 1234 is set. Here, the list box 1231 for selecting a prize category may include a list of shopping malls or a list of product types according to an embodiment.

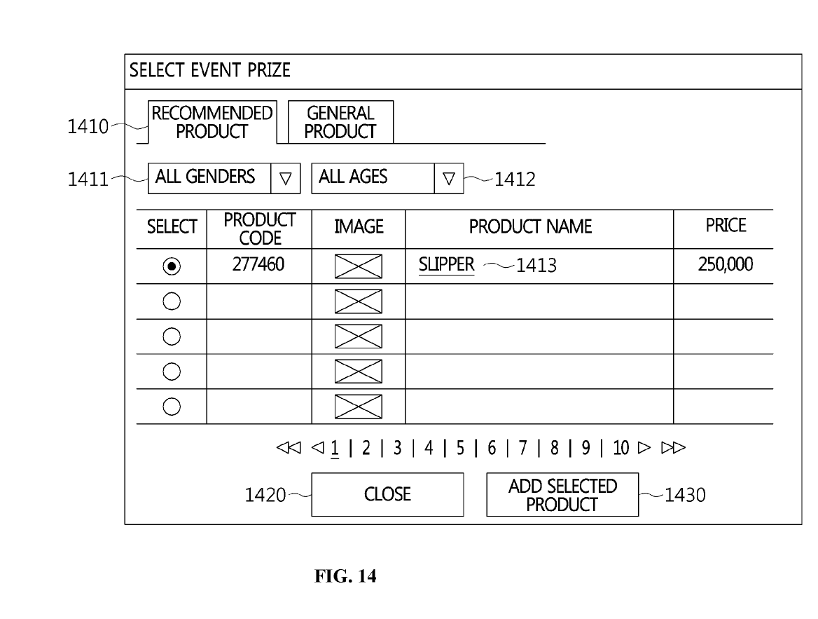

Here, when the ‘select product’ button 1232 is clicked, a page for selecting the product to be offered as a prize may be provided as shown in FIG. 14.

Also, the page may move back to the step of setting a game, illustrated in FIG. 11, by clicking the ‘previous’ button 1240, or the step of creating the advertising event may be continued by clicking the ‘next’ button 1250. Here, the ‘next’ button 1250 is disabled by default, but may be switched to an enabled state when all required items are input. Here, the required items may be information through which all matters pertaining to rewards may be finalized.

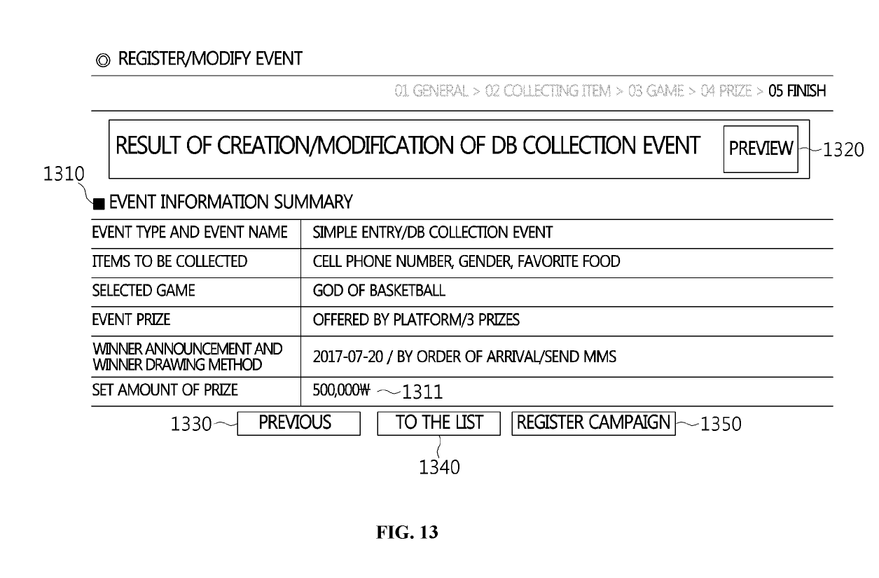

FIG. 13 is an advertising event creation page that displays event summary information 1310 about advertising event data to be created or having been created as a result of setting information about the advertising event.

In an embodiment, the advertising event creation page illustrated in FIG. 13 may be displayed as the next step of the advertising event creation page illustrated in FIG. 12.

Here, the event summary information 1310 may include the advertising event type, the advertising event name, the items to be collected, the selected game, the reward information, the set amount of a reward 1311, and the like, but items, the values of which are not set, may not be displayed. The set amount of a reward 1311 may be calculated from the set reward information. For example, when a reward is ten gift certificates, each of which is valued at ten dollars, the amount of the reward may be calculated at one hundred dollars.

Also, when the ‘preview’ button 1320 is clicked, the advertising event page to be shown to participants may be checked. Here, the advertising event preview page may be provided in the form of a window, a tab, or a pop-up window.

Also, the page may move back to the step of setting reward information, illustrated in FIG. 12, by clicking the ‘previous’ button 1330, or the page may move to a list page, in which a list of created advertising events is displayed, by clicking the ‘to the list’ button 1340. Also, when the ‘register campaign’ button 1350 is clicked, an advertising event is publicized by registering the advertising event data (advertising event campaign), whereby entry into the advertising event is permitted.

FIG. 14 is a view that shows an example of a page for selecting a product to be offered as a reward according to an embodiment of the present invention.

In an embodiment, the page shown in FIG. 14 may be displayed when the ‘select product’ button 1232 in FIG. 12 is clicked.

Specifically, the page for selecting a product to be offered as a reward may include tabs 1410, each of which shows recommended products or general products. When products recommended based on the result of analysis of advertising event results are present, the ‘recommended product’ tab shows the recommended products, and a user may select the ‘recommended product’ tab in order to check the recommended products. In order to select a product without recommendation, the ‘general product’ tab, in which a user may select a product by himself or herself, may be selected.

Here, when recommended products are present, the ‘recommended product’ tab is selected by default, but when there is no recommended product, the ‘general product’ tab may be selected by default.

Then, a product list is displayed in order to enable a user to select a product. Here, the product list may display the list of the products that are filtered by the conditions, which are set using the combo box 1411 for selecting a gender and the combo box 1412 for selecting an age group. The combo box 1412 for selecting an age group may show age groups broken into five- or ten-year intervals.

Also, the product list may include information such as product code, a product image, a product name, a price, and the like.

Here, the product name 1413 may be displayed in the form of a hyperlink to the page of a connected shopping-mall platform that sells the corresponding product. Accordingly, the user (200 in FIG. 1) may easily access the page that sells the corresponding product merely by clicking the product name 1413, and may check necessary information. The address of the page selling the product may be configured as ‘the domain of a shopping mall +product code’.

Also, when the ‘close’ button 1420 is clicked, the page may move back to the page for setting reward information without selecting a product. When the ‘add selected product’ button 1430 is clicked, the selected product is set to the product to be offered as a reward, and then the page may move back to the page for setting reward information.

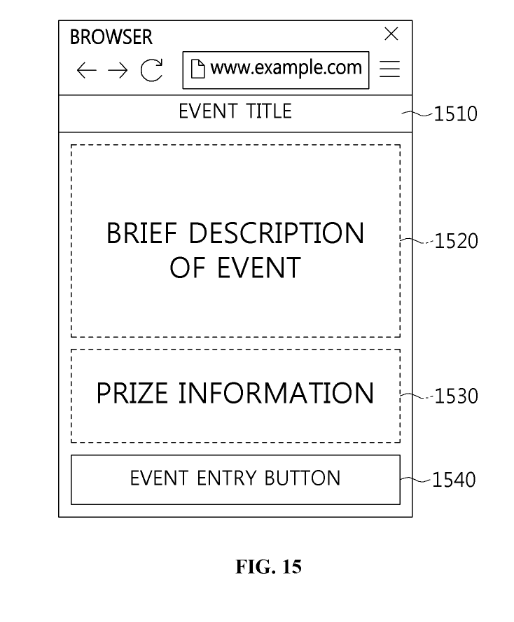

FIGS. 15 to 21 are views that show an example of an advertising event page according to an embodiment of the present invention.

Here, the advertising event page, illustrated in FIGS. 15 to 21, may be an advertising event page to be provided to a participant via the participant terminal (400 in FIG. 1), and may be an advertising event preview page provided to the user (200 in FIG. 1).

FIG. 15 is the introduction page or the start page of an advertising event, and may include an event name or an event title 1510, a brief description 1520 of an event, prize information 1530, an event entry button 1540, and the like.

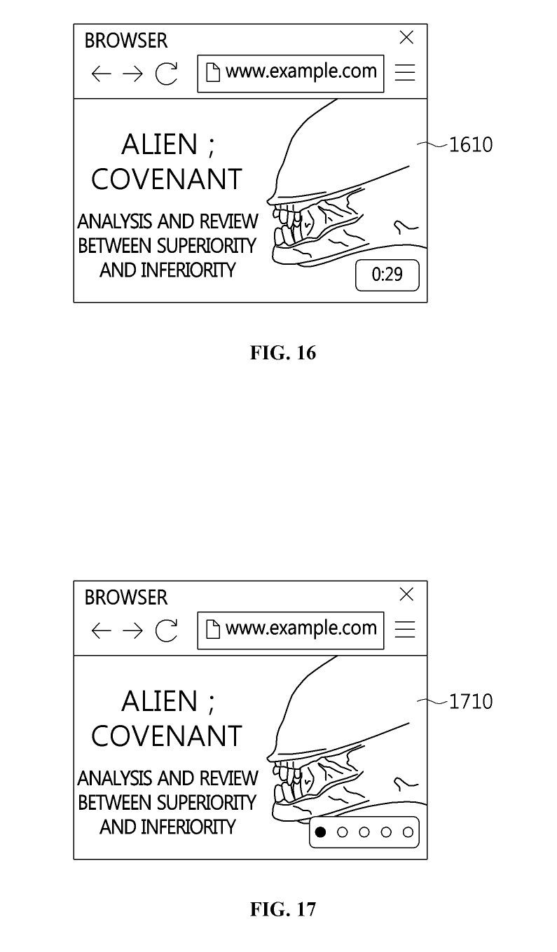

FIG. 16 is an advertisement page displayed when a video advertisement 1610 is included in the advertising event. Here, the video advertisement may be displayed by being included in the brief description 1520 of the event, illustrated in FIG. 15, or a separate page including the video advertisement may be newly loaded or may pop up when the event entry button 1540 illustrated in FIG. 15 is clicked.

FIG. 17 is an advertisement page displayed when an image advertisement 1710 is included in the advertising event. Here, the image advertisement may be displayed by being included in the brief description 1520 of the event, illustrated in FIG. 15, or a separate page including the image advertisement may be newly loaded or may pop up when the event entry button 1540 illustrated in FIG. 15 is clicked.

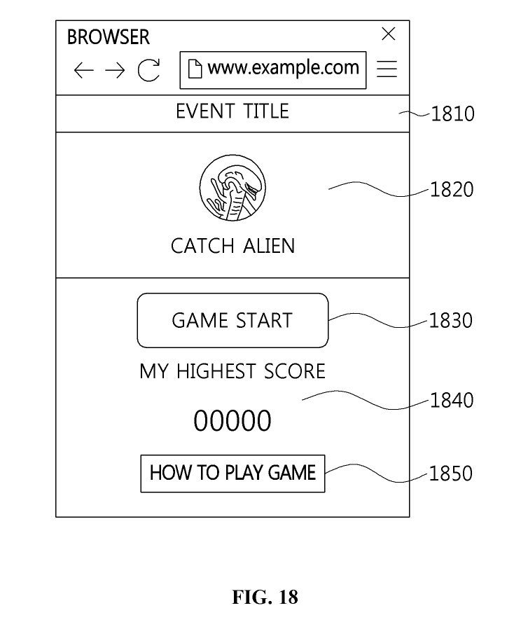

FIG. 18 is the introduction page or the start page of a mini-game included in an advertising event, and may be displayed when the event entry button 1540 illustrated in FIG. 15 is clicked. The page may include an event name 1810, a mini-game name 1820, a game start button 1830, the highest score 1840, a game description button 1850, and the like. When the game description button 1850 is clicked, information such as a brief description of the mini-game, game rules, and the like may be provided in a pop-up window.

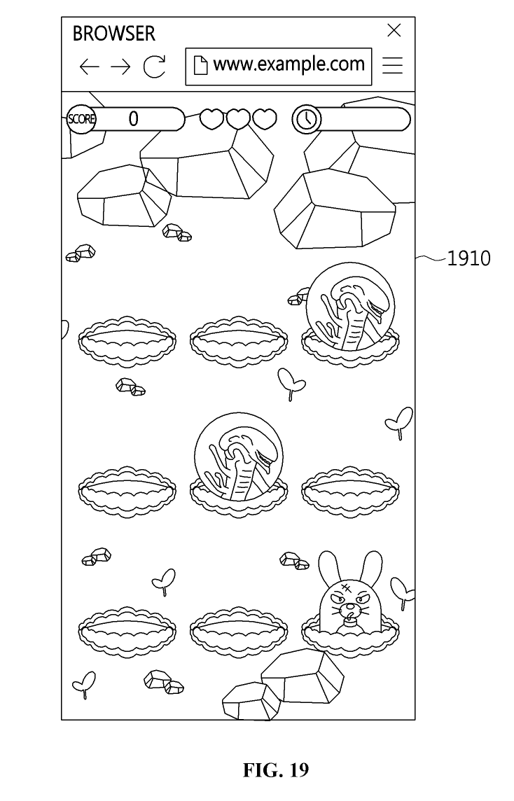

FIG. 19 is a mini-game page, and may be displayed when the game start button 1830 illustrated in FIG. 18 is clicked. This page includes the mini-game 1910 that is set as the advertising event content.

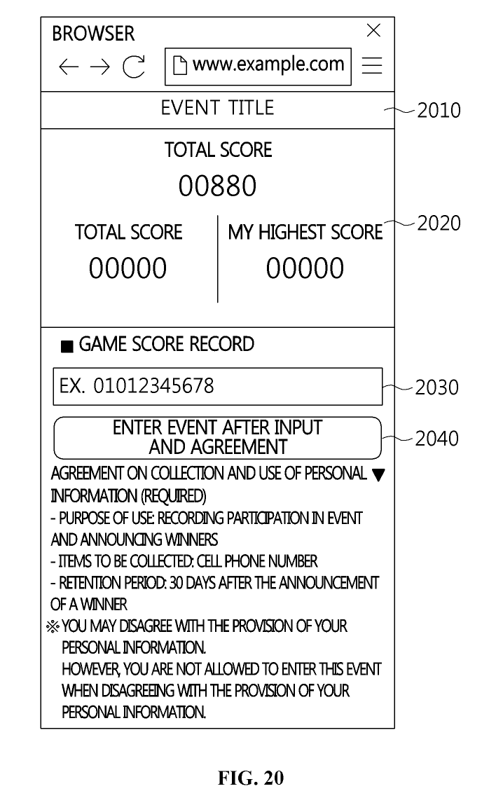

FIG. 20 is a page that shows the result of participation in the mini-game, and may be displayed when the mini-game 1910 shown in FIG. 19 finishes. The page may include the event name 2010, the score 2020, the participant information input window 2030, the participation button 2040, and the like. Information required to enter the advertising event may be input via the participant information input window 2030, and the participant may enter the event after agreeing with the provision of the input personal information by clicking the participation button 2040.

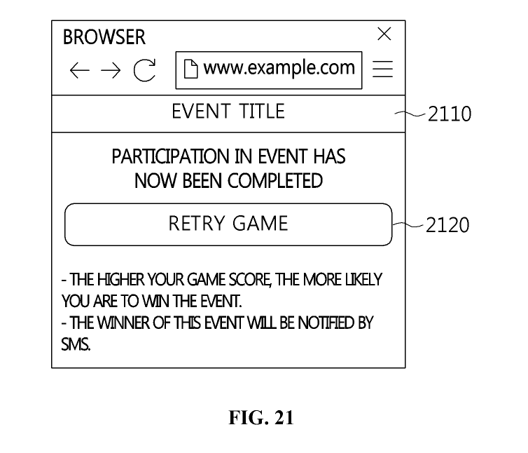

FIG. 21 is an advertising event participation completion page, and may be displayed when participation in the advertising event is successfully completed by clicking the participation button 2040 illustrated in FIG. 20. The page may include the event title 2110, an event participation completion message, a mini-game retry button 2120, and the like. The participant may retry the mini-game of the advertising event by clicking the mini-game retry button 2120, and the mini-game start page illustrated in FIG. 18 may be displayed when the mini-game retry button 2120 is clicked.

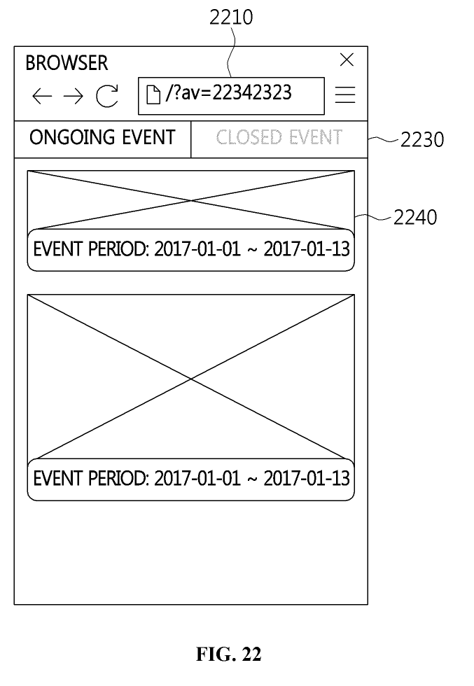

FIG. 22 is a view that shows an example of an advertising event list page according to an embodiment of the present invention.

Referring to FIG. 22, the advertising event list page according to an embodiment of the present invention includes an ongoing event tab 2220, a completed event tab 2230, and the like, and only advertising events pertaining to a certain advertiser may be displayed.

In this case, the address 2210 of the advertising event list page may be configured as ‘server domain +advertiser code’. For example, when the server domain and the advertiser code are ‘www.example.com’ and ‘22342323’, respectively, the address of the advertising event list page for the advertiser may be ‘http://www.example.com/?av=22342323’. Accordingly, when the address is accessed, a list of events in progress or a list of completed events pertaining to the advertiser may be displayed.

When the ongoing event tab 2220 is enabled, a list of the advertising events 2240 that are currently progressing may be displayed, but when the completed event tab 2230 is enabled, a list of the completed advertising events may be displayed. Also, when an advertising event is selected from the list, the page may move to a page that shows the summary information of the selected advertising event or the result of the selected advertising event.

Particularly, the advertising event list page may be inserted in or implemented to a desired webpage, site, or the like. Also, a fee may be charged when the advertising event list page is accessed or a fee to be charged may be set when permissions for accessing the advertising event list are determined.

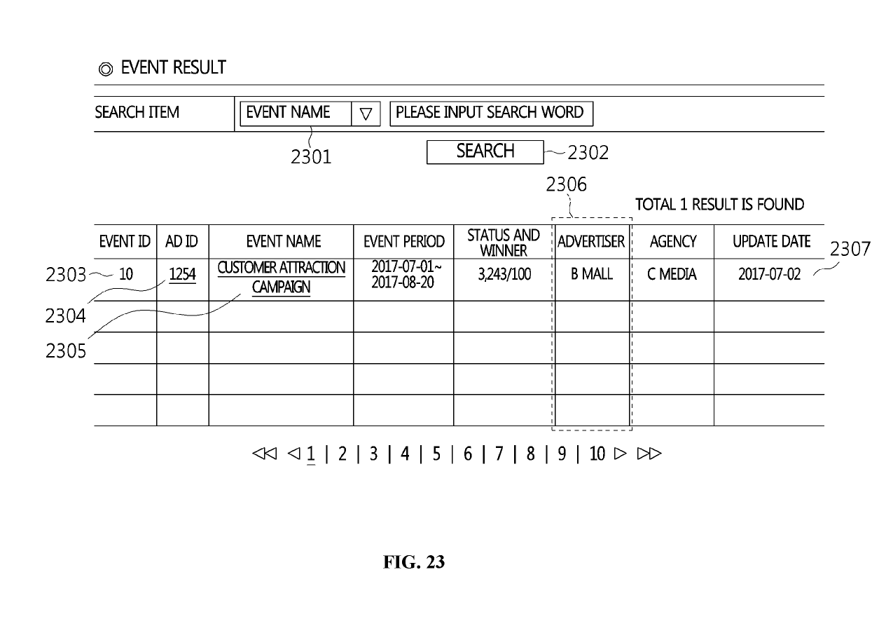

FIG. 23 is a view that shows an example of an advertising event result page according to an embodiment of the present invention.

Referring to FIG. 23, the advertising event result page according to an embodiment of the present invention may include a list box 2301 for selecting a category in which a search word is included, a search word input field, a search button 2302, a search result, and the like in order to enable searching for an advertising event.

Here, in the list box 2301 for selecting a search word category, ‘event name’ may be selected by default, and ‘event name’, ‘advertiser name’, ‘agency name’, ‘event period’, ‘event ID’, ‘advertisement ID’, and the like may be included.

When the search button 2302 is clicked, advertising events corresponding to the selected search word category and the search word are searched for, and the found advertising events are displayed. The search result may include an event ID 2303, an advertisement ID 2304, an event name 2305, an event period, current status information, an advertiser 2306, an agency, an update date 2307, and the like.

Here, the advertisement ID 2304 may be displayed in the form of a hyperlink to a page for displaying a report on the result of the corresponding advertising event. Also, the event name 2305 may be displayed in the form of a hyperlink to the page for checking or modifying the content of the corresponding advertising event. Alternatively, the event name 2305 may be displayed in the form of a hyperlink to the adverting event result details page of the corresponding advertising event. Also, the update date 2307 may be the date on which the advertising event was registered or on which the advertising event was most recently updated.

When the advertising event result page is accessed with the account of the advertiser, the advertiser 2306 field may not be displayed.

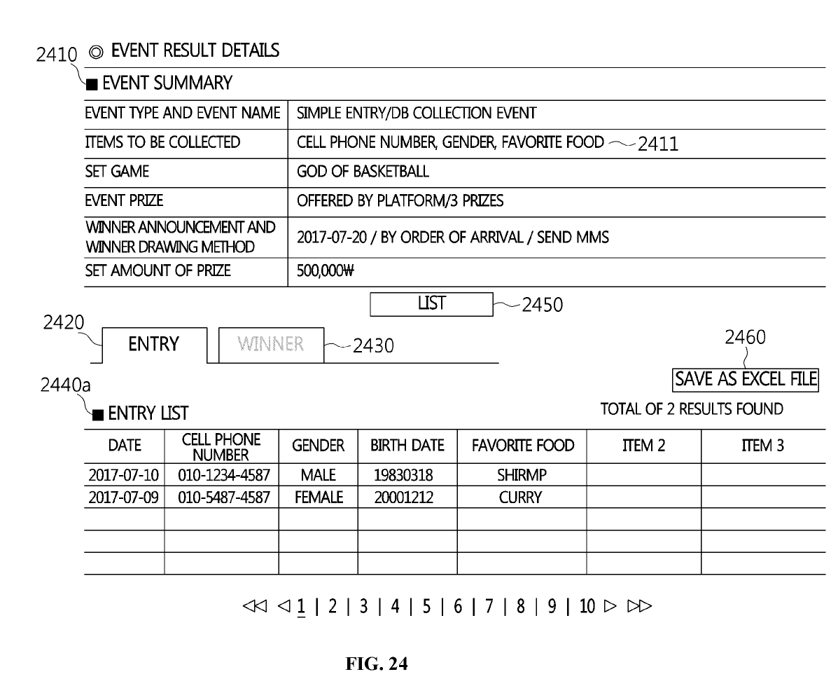

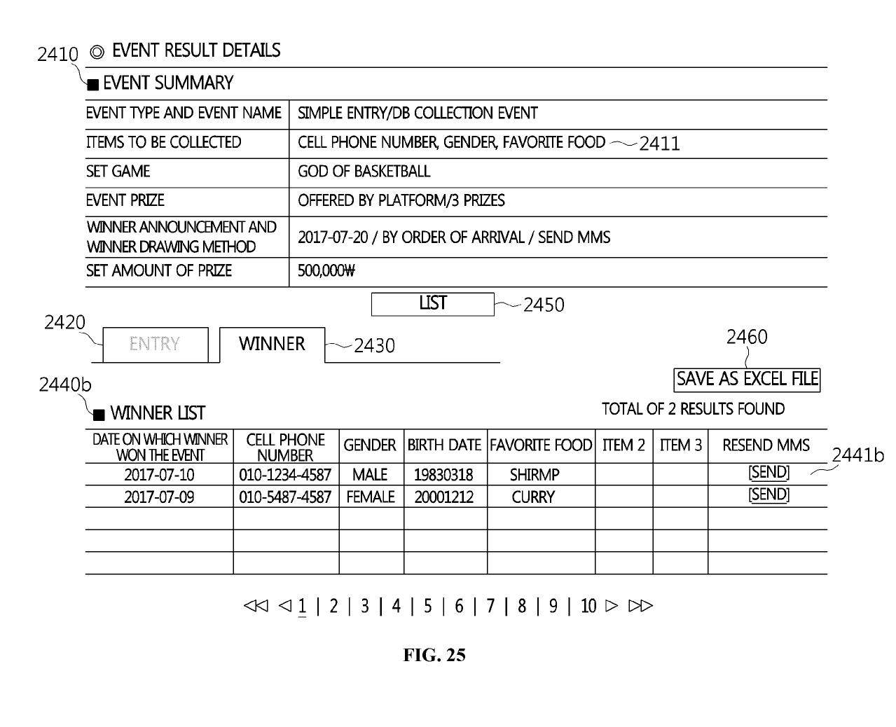

FIG. 24 and FIG. 25 are views that show an example of an advertising event result details page according to an embodiment of the present invention.

Referring to FIG. 24 and FIG. 25, the advertising event result details page according to an embodiment of the present invention includes event summary information 2410, an entry tab 2420, a winner tab 2430, an entry list 2440a or a winner list 2440b, a list button 2450, a download button 2460, and the like. Here, FIG. 24 shows an example of an advertising event result details page when the entry tab 2420 is enabled, and FIG. 25 shows an example of an advertising event result details page when the winner tab 2430 is enabled.

Here, the event summary information 2410 may include an advertising event type, an advertising event name, the collected items, the selected game, reward information, the set amount of a reward, and the like, but items, the values of which are not set, may not be displayed. The collected items 2411 may show items that are set to be collected in the advertising event.

When the entry tab 2420 is enabled, a list 2440a of entries may be displayed, and when the winner tab 2430 is enabled, a list 2440b of winners may be displayed. Here, the entry list 2440a may show participant information corresponding to the items that are set to be collected from participants. Also, the list 2440b of winners may include the date on which a winner won the event and a button or hyperlink 2441b for resending the notification of winning the event. When the notification of winning the event is sent again, the notification may be sent in the manner that is the same as the manner in which it is first set.

Also, an advertising event list page or an advertising event result page may be displayed by clicking the list button 2450. When the download button 2460 is clicked, the entry list 2440a or winner list 2440b may be download and saved as an Excel file or a spreadsheet file.

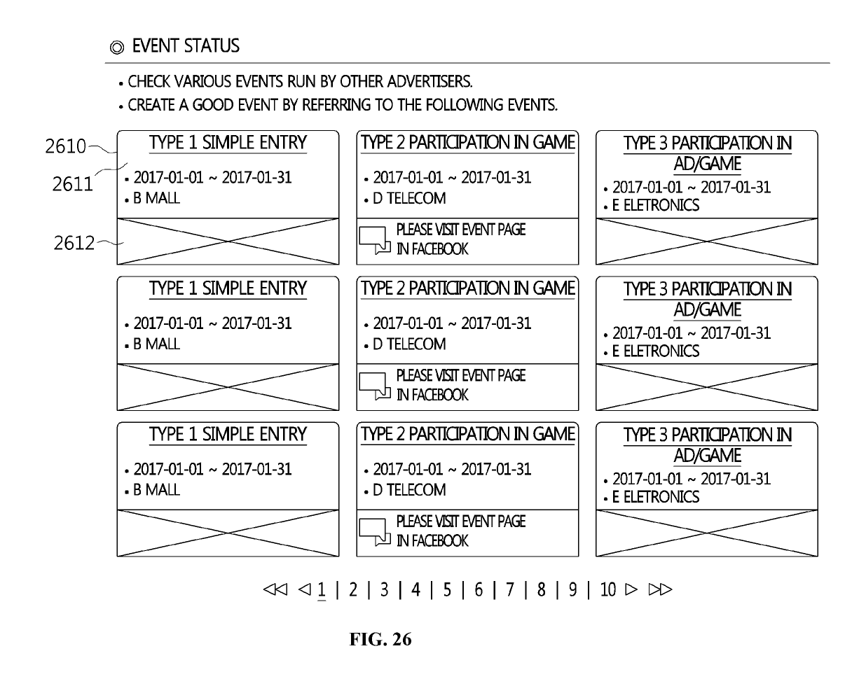

FIG. 26 is a view that shows an event status page according to an embodiment of the present invention.

Referring to FIG. 26, the event status page according to an embodiment of the present invention shows completed advertising events 2610.

Each of the advertising events 2610 includes advertising event information 2611 including an advertising event type, an advertisement period, advertiser information, and the like. Also, each of the advertising events 2610 may further include an advertising event banner 2612 that was used when the corresponding advertising event was run.

Here, when the advertising event banner 2612 is clicked, the advertising event preview page of the corresponding advertising event may be displayed. Here, the advertising event preview page may be provided in various forms, such as a window, a tab, a pop-up window, or the like.

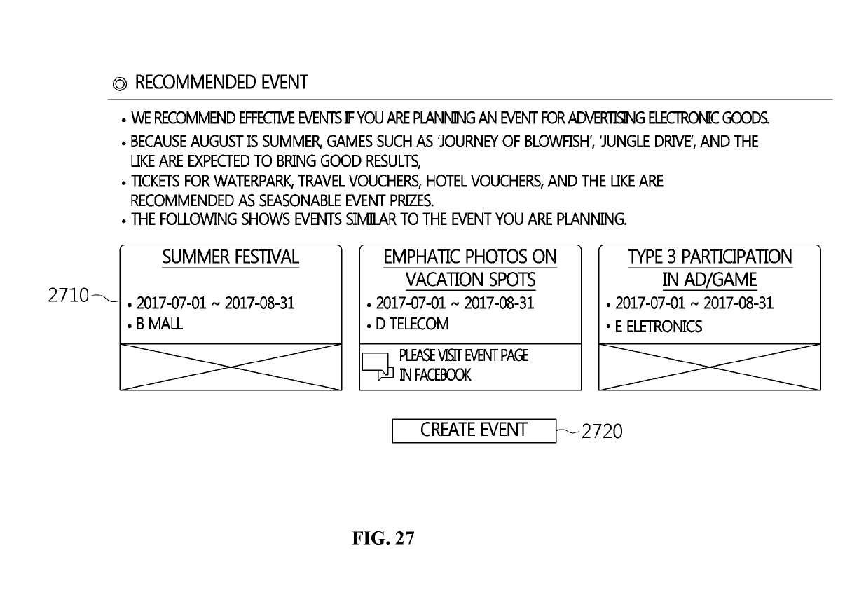

FIG. 27 is a view that shows an example of an event recommendation page according to an embodiment of the present invention.

Referring to FIG. 27, the event recommendation page according to an embodiment of the present invention provides information recommended for an advertising event in consideration of the category in which the product to be advertised is included, the time at which an advertisement is to be publicized, and the like. Also, among the advertising events that were run, advertising events 2710 that are similar to the advertising event that the user (200 in FIG. 1) intends to provide may be selected and displayed.

For example, when the product that the user (200 in FIG. 1) wants to advertise is included in an electronic device category, an advertising event type, advertising event content, and the like that have yielded good advertising effects in the electronic device category may be recommend. Also, when the time when the advertisement is to be publicized is August, mini-games related to summer may be recommended as game content, and tickets for a waterpark, associated with summer, may be recommended as rewards.

Also, an event creation button 2720 is provided so that the user (200 in FIG. 1) is prompted to move to the advertising event creation page.

The above-described embodiment of the present invention may be implemented as program instructions executable by various computer devices, and may be recorded in computer-readable storage media. The computer-readable storage media may separately or collectively include program instructions, data files, data structures, and the like. The program instructions recorded in the media may be specially designed and configured for the embodiment, or may be available by being well known to computer software experts. Examples of the computer-readable storage media include magnetic media such as a hard disk, a floppy disk and a magnetic tape, optical media such as a CD-ROM and a DVD, and magneto-optical media such as a floptical disk, ROM, RAM, flash memory, and the like, that is, a hardware device specially configured for storing and executing program instructions. Examples of the program instructions include not only machine code made by a compiler but also high-level language code executable by a computer using an interpreter. The above-mentioned hardware device may be configured such that it operates as one or more software modules in order to perform the operations of the embodiment, and vice-versa.

According to the present invention, through the apparatus and method for providing an advertising-event-authoring tool, an advertiser may easily and efficiently create various types of advertising events.

Also, through the apparatus and method for providing an advertising-event-authoring tool, the present invention enables content obtained from a content library to be added to an advertising event, whereby already created content may be easily used without the need to newly create content to be included in an advertising event.

Also, through the apparatus and method for providing an advertising-event-authoring tool according to the present invention, advertising event content is read from a content platform such as a separate content store, whereby content developers may be motivated to create various kinds of high-quality content.

Also, through the apparatus and method for providing an advertising-event-authoring tool, the present invention collects information about the results of created advertising events and provides statistical information based thereon, whereby the effects of the advertising events may be analyzed, and advertising content that is capable of enhancing the effect of an advertising event depending on the circumstances may be determined.

Also, through the apparatus and method for providing an advertising-event-authoring tool according to the present invention, an event method and rewards that are advantageous to an advertiser are determined and recommended based on collected statistical information, whereby a more effective advertising event may be created, and the result of the advertising event may be predicted.

Although specific embodiments have been described in the specification, they do not limit the scope of the present invention. For the conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, corresponding components may not be absolutely necessary.

Accordingly, the spirit of the present invention should not be construed as being limited to the above-described embodiments, and the entire scope of the appended claims and their equivalents will fall within the scope and spirit of the present invention.

What is claimed is:

1. An apparatus for providing an advertising-event-authoring tool, comprising:
an advertising product information setting unit for setting information about a product to be advertised, which is a target of an advertising event, depending on input from a user or a user terminal;
an advertising event type setting unit for setting an advertising event type;
an advertising event content setting unit for setting advertising event content;
a reward information setting unit for setting information about rewards for participants in the advertising event; and
an advertising event data generation unit for generating advertising event data depending on the set information.

2. The apparatus of claim 1, wherein the advertising event content setting unit provides a content list of a content library to the user, and adds content selected by the user as the advertising event content.

3. The apparatus of claim 2, wherein:
the content library is a content platform library in a content platform, or a content platform library received from the content platform, and
the content platform is configured to store content in a form of a library in the content platform library, produced and registered by a content producer, and to provide the registered content to users, either for payment or at no cost based on a set pricing model.

4. The apparatus of claim 1, wherein:
the advertising event content includes one or more of text, an image, sound, a video, an animation, and a mini-game, and
the advertising event content setting unit changes one or more of a difficulty level, an item, a background, a character, an object, and a goal of the mini-game based on the information about the product to be advertised, thereby creating a mini-game customized to the product to be advertised.

5. The apparatus of claim 1, further comprising:
an advertising result analysis unit for collecting advertising results of advertising events that are created and underway or completed, generating statistical information based thereon, and analyzing a correlation of the advertising results with one or more of a type of the product to be advertised, the advertising event type, the advertising event content, and the information about the rewards.

6. The apparatus of claim 5, wherein:
the advertising result analysis unit selects at least one of a recommended advertising event type, recommended advertising event content, and recommended reward information suitable for the product to be advertised, using the correlation;
when there is a recommended advertising event type corresponding to the product to be advertised, the advertising event type setting unit provides the recommended advertising event type;
when there is recommended advertising event content corresponding to the product to be advertised, the advertising event content setting unit provides the recommended advertising event content; and
when there is recommended reward information corresponding to the product to be advertised, the reward information setting unit provides the recommended reward information.

7. The apparatus of claim 1, wherein the advertising event type setting unit provides an advertising-event-authoring template corresponding to the advertising event type when the advertising event type is set.

8. The apparatus of claim 1, further comprising:
an advertising event preview provision unit for providing a preview screen for an advertising event based on the set information.

9. The apparatus of claim 5, wherein the advertising result analysis unit calculates a predicted advertising result corresponding to a target advertising event using an event parameter and a media parameter, the event parameter being calculated from at least one of an event time, an event type, a type of prize, a number of prizes, and a target group for advertising events that are created and underway or completed, and the media parameter being calculated from at least one of a type of event media corresponding to the advertising events, a characteristic of the event media, and a demographic group that mainly uses the event media.

10. The apparatus of claim 9, wherein the predicted advertising result is provided during a process of creating the target advertising event or before the target advertising event is started, and includes at least one of an estimated number of participants and an estimated number of entries.

11. A method for providing an advertising-event-authoring tool, comprising:
setting information about a product to be advertised, which is a target of an advertising event, depending on input from a user or a user terminal;
setting an advertising event type;
setting advertising event content;
setting information about rewards for participants in the advertising event; and
generating advertising event data depending on the set information.

12. The method of claim 11, wherein setting the advertising event content is configured to provide a content list of a content library to the user, and to add content selected by the user as the advertising event content.

13. The method of claim 12, wherein:
the content library is a content platform library in a content platform or a content platform library received from the content platform, and
the content platform is configured to store content in a form of a library in the content platform library, produced and registered by a content producer, and to provide the registered content to users, either for payment or at no cost depending on a set pricing model.

14. The method of claim 11, wherein:
the advertising event content includes one or more of text, an image, sound, a video, an animation, and a mini-game, and
setting the advertising event content is configured to change one or more of a difficulty level, an item, a background, a character, an object, and a goal of the mini-game based on the information about the product to be advertised, and to thereby create a mini-game customized to the product to be advertised.

15. The method of claim 11, further comprising:
analyzing advertising result by collecting advertising results of advertising events that are created and underway or completed, generating statistical information based thereon, and analyzing a correlation of the advertising results with one or more of a type of the product to be advertised, the advertising event type, the advertising event content, and the information about the rewards.

16. The method of claim 15, wherein:
analyzing the advertising results is configured to select at least one of a recommended advertising event type, recommended advertising event content, and recommended reward information suitable for the product to be advertised, using the correlation;
setting the advertising event type is configured to provide a recommended advertising event type when there is the recommended advertising event type corresponding to the product to be advertised;
setting the advertising event content is configured to provide recommended advertising event content when there is the recommended advertising event content corresponding to the product to be advertised; and
setting the information about the rewards is configured to provide recommended reward information when there is the recommended reward information corresponding to the product to be advertised.

17. The method of claim 11, wherein setting the advertising event type is configured to provide an advertising-event-authoring template corresponding to the advertising event type when the advertising event type is set.

18. The method of claim 15, wherein analyzing the advertising results is configured to calculate a predicted advertising result corresponding to a target advertising event using an event parameter and a media parameter, the event parameter being calculated from at least one of an event time, an event type, a type of prize, a number of prizes, and a target group for advertising events that are created and underway or completed, and the media parameter being calculated from at least one of a type of event media corresponding to the advertising events, a characteristic of the event media, and a demographic group that mainly uses the event media.

19. The method of claim 18, wherein the predicted advertising result is provided during a process of creating the target advertising event or before the target advertising event is started, and includes at least one of an estimated number of participants and an estimated number of entries.
